(19) United States
(12) Patent Application Publication
(10) Pub. No.: US 2009/0196421 A1
(43) Pub. Date: Aug. 6, 2009

(54) METHOD OF ENCRYPTION AND DECRYPTION, TRANSMITTER, AND RECEIVER IN RADIO COMMUNICATION SYSTEM

(75) Inventor: Masato OKUDA, Kawasaki (JP)

Correspondence Address: MYERS WOLIN, LLC, 100 HEADQUARTERS PLAZA, North Tower, 6th Floor, MORRISTOWN, NJ, 07960-6834, US

(73) Assignee: FUJITSU LIMITED, Kawasaki-shi (JP)

(21) Appl. No.: 12/262,126

(22) Filed: Oct. 30, 2008

(30) Foreign Application Priority Data
Feb. 6, 2008 (JP) 2008-026753

(51) Int. Cl. H04L 9/28; G08C 25/02; G06F 11/07

(52) U.S. Cl. 380/270; 714/748; 714/E11.023

(57) ABSTRACT

A transmitter encrypts data blocks using the encryption key and variable number information (CTR) sequentially updated for every encryption of the respective data blocks; selectively attaches one of the variable number information (CTR) used for encrypting the respective data blocks, to the encrypted data block; and transmits the encrypted data blocks to a receiver. The receiver determines, based on (a) reception orders of a first encrypted data block with the variable number information (CTR) attached and a second encrypted data block without the variable number information (CTR) attached and (b) the variable number information (CTR) attached to the first encrypted data block, variable number information (CTR) used for encrypting the second encrypted data block; and decrypts the second encrypted data block using the determined variable number information (CTR) and the decryption key.

### CROSS-REFERENCE TO RELATED APPLICATION(S)

This application is based upon and claims the benefit of priority of the prior Japanese Application No. 2008-026753 filed on Feb. 6, 2008 in Japan, the entire contents of which are hereby incorporated by reference.

### FIELD

The embodiment (s) discussed herein is directed to a method of encryption and decryption, transmitters, and receivers in radio communication system. For example, the embodiment (s) may be used in encrypting and transmitting packets or receiving and decrypting packets.

### BACKGROUND

One known technology for encrypting data and guaranteeing the integrity of data in packet communication is Advanced Encryption Standard-Counter with Cipher Block Chaining-Message Authentication Code (CBC-MAC) (AES-CCM).

For example, for Internet Protocol (IP), RFC4309, “Using Advanced Encryption Standard (AES) CCM Mode with IPsec Encapsulating Security Payload (ESP)” describes an example format for encrypting data using AES-CCM, which is illustrated in FIG. 23.

In FIG. 23, IV, which stands for Initialization Vector, is attached to respective encrypted data (Encrypted Payload) at, e.g., the beginning thereof. IV represents a variable (e.g., 8-byte value) each value of which can be used only once for a certain encryption key, and is optionally generated and used for encryption by an encrypting party. Where, “a variable each value of which can be used only once for a certain encryption key” means that one value of IV that has been used for encrypting one packet can not be used for encrypting another packet using the same encryption key.

In order to ensure the uniqueness of IV, a counter value can be used as IV, for example, which is incremented by 1 for every encryption of respective packets. Transmission of an encrypted packet with such an IV attached allows a recipient (decrypting party) to receive and decrypt the encrypted packet using the IV attached to the received encrypted packet and a decryption key paired with the encryption key.

Also, in FIG. 23, AD, which stands for Authentication Data, is attached to Encrypted Payload at, e.g., the end thereof. The AD includes information for authenticating a packet, e.g., the result of hash value calculation for Encrypted Payload.

Note that the format illustrated in FIG. 23 is contained in the payload of an IP packet and encapsulated, i.e., with IP header etc. further attached.

AES-CCM algorithm described above may also be used in radio packet communication. For example, the IEEE 802.16 specification, which may be simply referred to as “802.16 spec” hereafter, described in IEEE Std 802.16(TM)-2004 and IEEE Std 802.16e(TM)-2005 defined by IEEE 802.16 Working Group (WG) defines packet encryption using AES-CCM algorithm.

The 802.16 spec defines point-to-multipoint (P-MP) communication scheme enabling multiple terminals to be connected to one base station. Also, the 802.16 spec includes the IEEE 802.16d (IEEE802.16-2004) for fixed wireless communication and IEEE 802.16e (IEEE802.16e-2005) for mobile communication. Both of them define more than one physical layers, which mainly use techniques such as Orthogonal Frequency Division Multiplexing (OFDM), Orthogonal Frequency Division Multiple Access (OFDMA), etc.

FIG. 24 illustrates an example packet format using AES-CCM algorithm in accordance with the 802.16 spec. In FIG. 24, CTR, which is attached to the beginning of encrypted data (Encrypted Payload), is a variable each value of which can be used only once for a certain encryption key, and is, for example, a counter value being incremented by 1 for every encryption of respective packets by a sender (encrypting party). Thus, the uniqueness of CTR value for a certain encryption key can be ensured as described above regarding AES-CCM for IP. Note that an encryption key may be changed after CTR values go around. As a result, any value of CTR is not used twice for the same encryption key.

A recipient (decrypting party) receives and decrypts an encrypted packet using the CTR value attached to the received encrypted packet and a decryption key paired with the encryption key.

Also, in FIG. 24, ICV, which stands for Integrity Check Value, is attached to the end of Encrypted Payload, and includes the result of hash value calculation for authenticating a packet.

Note that the format illustrated in FIG. 24 is contained, for example, in payload of Media Access Control-Protocol Data Unit (MAC-PDU) defined by the 802.16 spec. In this case, for example, Media Access Control (MAC) header, Cyclic Redundancy Check (CRC) code, etc. are further attached to this format, as illustrated in FIG. 25.

In the 802.16 spec, such formatted MAC-PDU is mapped to radio frame and transmitted. In OFDM or OFDMA, a radio frame includes multiple transmission/reception blocks called burst, each represented as a two-dimensional block of frequency and time.

FIG. 26 illustrates an example format of radio frame in OFDMA. In FIG. 26, the vertical and horizontal axis indicates frequency (sub-channel) and time (symbol), respectively. In time direction, one radio frame includes a downlink (DL) sub-frame with a fixed-pattern preamble (Preamble) signal at its beginning, a Transmit/Receive Transition Gap (TTG) of constant duration, an uplink (UL) sub-frame, and a Receive/Transmit Transition Gap (RTG) of constant duration, followed by the preamble signal of the next DL sub-frame, in this order.

Where, DL sub-frame is a frame transmitted from a Base Station (BS) to a Mobile Station (MS), while UL sub-frame is a frame transmitted from a MS to a BS.

Preamble signal is a fixed-pattern signal used for a MS to detect a BS and establish synchronized radio link with the BS, i.e., a synchronizing signal. DL-MAP and UL-MAP is a signal that includes information regarding the allocation of radio resource (burst) in DL and UL sub-frame for MS, such as targeted MS, modulation scheme used, error correction code, etc. Frame Control Header (FCH) is a signal that defines information on BS and information, called burst profile, used for MS to demodulate and decrypt DL sub-frame (burst).

Thus, MS can establish synchronization with radio frames transmitted from BS by detecting a preamble signal of a DL subframe, and can know what burst (frequency and timing) in radio frame to use to communicate with BS and what modulation/demodulation scheme and error correction code to use, by demodulating and decrypting DL-MAP and UL-MAP based on FCH.

In this radio frame format, one burst can include more than one PDU. FIG. 27 illustrates an example image of combining more than one MAC-PDUs and containing them in one burst. In FIG. 27, three MAC-PDUs are combined and mapped to one burst.

In prior arts described above, information, such as IV or CTR, the uniqueness of which should be ensured for a certain encryption key (e.g., sequential number being incremented for every encryption) is attached to each encrypted packet, such as IP packet or MAC-PDU (i.e., to every encrypted packet).

This leads to an increase in the quantity of overhead of encrypted packets. That would be disadvantage in communication throughput, use efficiency of communication (radio) resources such as bandwidths, etc.

### SUMMARY

For example, exemplary embodiment(s) uses the following.

(1) According to an exemplary embodiment, there is provided a method of encryption and decryption in a radio communication system including a transmitter which encrypts data using an encryption key and transmits the encrypted data to a radio link and a receiver which receives the encrypted data via the radio link and decrypts the encrypted data using a decryption key paired with the encryption key, the method including: at the transmitter, encrypting data blocks using the encryption key and variable number information, the variable number information being sequentially updated for every encryption of the respective data blocks; selectively attaching one of the variable number information used for encrypting the respective data blocks, to the encrypted data block encrypted by using one of the variable number information; and transmitting the encrypted data blocks including the encrypted data block with the variable number information attached, to the receiver; at the receiver, determining, based on (a) reception orders of a first encrypted data block with the variable number information attached and a second encrypted data block without the variable number information attached and (b) the variable number information attached to the first encrypted data block, variable number information used for encrypting the second encrypted data block; and decrypting the second encrypted data block using the determined variable number information and the decryption key.

(2) The encrypted data block with the variable number information attached by the transmitter may be one of the more than one encrypted data blocks included in a predetermined transmission unit.

(3) Also, the encrypted data block with the variable number information attached in the transmission unit may be the encrypted data block to be transmitted at the beginning of the transmission unit.

(4) Furthermore, the transmitter may control the number of the encrypted data blocks with the variable number information attached, depending on information indicating channel performance between the receiver and itself.

(5) Also, the control may be such control that increases the number of the encrypted data blocks with the variable number information attached if the information indicating the channel performance is getting worse.

(6) Furthermore, the receiver, in response to detecting an error in the first encrypted data block with the variable number information attached, may transmit an identifying information identifying the first encrypted data block with the error detected, to the transmitter, and the transmitter, in response to receiving the identifying information, may retransmit the variable number information attached to the encrypted data block identified by the identifying information, to the receiver.

(7) Also, the receiver, in response to detecting an error in the first encrypted data block with the variable number information attached, may transmit a retransmission request for the first encrypted data block with the error detected, to the transmitter, and the transmitter, in response to receiving the retransmission request, may transmit the variable number information attached to the encrypted data block associated with the retransmission request, to the receiver.

(8) According to an exemplary embodiment, there is provided a transmitter in a radio communication system including a transmitter which encrypts data using an encryption key and transmits the encrypted data to a radio link and a receiver which receives the encrypted data via the radio link and decrypts the encrypted data using a decryption key paired with the encryption key, the transmitter including: an encryption unit operable to encrypt data blocks using the encryption key and variable number information, the variable number information being sequentially updated for every encryption of the respective data blocks; and an transmission unit operable to selectively attach one of the variable number information used for encrypting the respective data blocks, to the encrypted data block encrypted by using the one of the variable number information, and to transmit the encrypted data blocks including the encrypted data block with the variable number information attached, to the receiver.

(9) The transmission unit may attach one of the variable number information used for encrypting the respective data blocks, to the encrypted data block encrypted by using the one of the variable number information, among the encrypted data blocks included in a predetermined transmission unit.

(10) Also, the transmission unit may attach the variable number information to the encrypted data block to be transmitted at the beginning of the transmission unit.

(11) Furthermore, the transmitter may include a control unit operable to control the number of the encrypted data blocks with the variable number information attached, depending on information indicating channel performance between the receiver and itself.

(12) Also, the control unit may increase the number of the encrypted data blocks with the variable number information attached if the information indicating the channel performance is getting worse.

(13) Furthermore, the control unit may receive information that the receiver measured based on a signal received from the transmitter, from the receiver as information indicating the channel performance.

(14) Also, the information indicating the channel performance may be such information that indicates the quality of radio channel in the radio link.

(15) Furthermore, the information indicating the channel performance may be such information that relates to the frequency of retransmitting the encrypted data block to the receiver.

(16) Also, the transmitter may further include a reception unit operable to, when the receiver detects an error in the encrypted data block with the variable number information attached, receive an identifying information for identifying the encrypted data with the error detected, transmitted by the receiver, and the transmission unit may retransmit the variable number information attached to the encrypted data block identified by the identifying information, to the receiver.

(17) Furthermore, the transmitter may further include a reception unit operable to, when the receiver detects an error in the encrypted data block with the variable number information attached, receive a retransmission request for the encrypted data block with the error detected, transmitted by the receiver, and when the reception unit receives the retransmission request, the transmission unit may transmit the variable number information attached to the first encrypted data block associated with the retransmission request, to the receiver.

(18) According to an exemplary embodiment, there is provided a receiver in a radio communication system including a transmitter which encrypts data using an encryption key and transmits the encrypted data to a radio link and a receiver which receives the encrypted data via the radio link and decrypts the encrypted data using a decryption key paired with the encryption key, the receiver including: a reception unit operable to receive from the transmitter, which encrypts data blocks using the encryption key and variable number information, the variable number information being sequentially updated for every encryption of the respective data blocks, selectively attaches one of the variable number information used for encrypting the respective data blocks, to the encrypted data block encrypted by using the one of the variable number information, and transmits the encrypted data blocks including the encrypted data block with the variable number information attached, the encrypted data blocks; a variable number information determination unit operable to determine, based on (a) reception orders of a first encrypted data block with the variable number information attached and a second encrypted data block without the variable number information attached and (b) the variable number information attached to the first encrypted data block, variable number information used for encrypting the second encrypted data block; and a decryption unit operable to decrypt the second encrypted data block using the variable number information determined by the variable number information determination unit and the decryption key.

(19) The receiver may further include a transmission unit operable to, in response to detecting an error in the first encrypted data block with the variable number information attached, transmit an identifying information identifying the first encrypted data block with the error detected, to the transmitter, and the decryption unit may perform the decryption using the variable number information that was attached to the first encrypted data block, being received from the transmitter in response to the transmission of the identifying information by the transmission unit.

(20) Also, the receiver may further include a transmission unit operable to, in response to detecting an error in the first encrypted data block with the variable number information attached, transmit a retransmission request for the first encrypted data block with the error detected, to the transmitter, and the decryption unit may perform the decryption using the variable number information that was attached to the first encrypted data block, being received from the transmitter in response to the retransmission request by the transmission unit.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates how more than one PDU are mapped to a physical burst;

FIG. 2 illustrates an example configuration of a radio communication system in accordance with a first embodiment;

FIG. 3 is a block diagram illustrating an example configuration of a base station (BS) depicted in FIG. 2;

FIG. 4 is a block diagram illustrating an example configuration of a mobile station (MS) depicted in FIG. 2;

FIG. 5 is a sequence diagram illustrating a negotiation for omitting a CTR in the radio communication system depicted in FIG. 2;

FIG. 6 is a flowchart illustrating an example operation of the BS or MS depicted in FIGS. 2 and 3 as an encryptor;

FIG. 7 is a flowchart illustrating an example operation of the MS or BS depicted in FIGS. 2 and 3 as a decryptor;

FIG. 8A illustrates an example format of a PDU with a CTR value attached;

FIG. 8B illustrates an example format of a PDU with no CTR value attached;

FIG. 9 illustrates an example of an error occurring in some of the bursts in the radio communication system;

FIG. 10 illustrates that decryption is possible even if an error occurs in some of the bursts in the radio communication system in accordance with a second embodiment;

FIG. 11 is a flowchart illustrating an example operation of the BS or MS as an encryptor in accordance with the second embodiment;

FIG. 12 is a block diagram illustrating an example configuration of the MS in accordance with a third embodiment;

FIG. 13 is a flowchart illustrating an example operation of the BS or MS as an encryptor in accordance with the third embodiment;

FIG. 14 illustrates an example of an error occurring in a PDU with a CTR value attached in the first, second, and third embodiments;

FIG. 15 illustrates an ARQ/HARQ control architecture in accordance with a fourth embodiment;

FIG. 16 is a sequence diagram illustrating an example sequence of retransmitting a CTR value in accordance with the fourth embodiment;

FIG. 17 is a flowchart illustrating an example operation (when receiving bursts) of the MS or BS as a decryptor in accordance with the fourth embodiment;

FIG. 18 is a flowchart illustrating an example operation (when receiving a CTR-RSP message) of the MS or BS as a decryptor in accordance with the fourth embodiment;

FIG. 19 is a flowchart illustrating an example operation (when receiving a CTR-REQ message) of the BS or MS as an encryptor in accordance with the fourth embodiment;

FIG. 20 is a sequence diagram illustrating an example sequence of retransmitting a CTR value in response to receiving NAK in accordance with a fifth embodiment;

FIG. 21 is a flowchart illustrating an example operation (when transmitting data) of the BS or MS as an encryptor in accordance with the fifth embodiment;

FIG. 22 is a flowchart illustrating an example operation (when receiving ACK/NAK) of the MS or BS as a decryptor in accordance with the fifth embodiment;

FIG. 23 illustrates an example format of encrypting data using AES-CCM;

FIG. 24 illustrates an example packet format using AES-CCM algorithm in accordance with the IEEE 802.16 spec;

FIG. 25 illustrates an example format of encapsulating the packet depicted in FIG. 24 into a MAC-PDU;

FIG. 26 illustrates an example format of radio frame in OFDMA; and

FIG. 27 illustrates how more than one PDU are mapped to a physical burst in the radio frame depicted in FIG. 26.

### DESCRIPTION OF EMBODIMENT(S)

Hereinafter, exemplary embodiments will be described with reference to accompanying drawings. The following exemplary embodiments are merely examples and do not intend to exclude various modifications and variations to the proposed method and/or apparatus that are not specifically described herein. Rather, various modifications or variations may be made to the embodiments (for example, by combining the exemplary embodiments) without departing from the scope and spirit of the proposed method and/or apparatus

### [A] Description of Examples

In exemplary embodiments described below, at a sender (encrypting party), information the uniqueness of which should be ensured for a certain encryption key (e.g., sequential number (CTR value) being sequentially updated (incremented) for every encryption) is selectively attached to only some (not all) of encrypted data (packets), enabling the reduction in the quantity of overhead of encrypted packets. In other words, in the stream, some encrypted data are transmitted with their respective CTR values attached, while other encrypted data are transmitted with no CTR value attached.

For example, assuming that, in the packet (PDU) format of the 802.16 spec (see FIG. 25), header, CTR, ICV, and CRC take 6, 4, 8, and 4 bytes, respectively, all portions of one packet except encrypted data portion (i.e., overhead) take 22 bytes in total. But, if CTR (4 bites) is not attached, one packet takes 18 bytes. Thus the reduction of overhead by (4/22)*100=18.2% would be possible. Not being limited to this example, as information like CTR value needs some non-zero information area, the attachment of no CTR value allows information area to be reduced accordingly.

On the other hand, if one value of CTR is attached to a received packet, a recipient (decrypting party) decrypts the received packet using the CTR value attached and a decryption key paired with the encryption key. If no CTR value is attached to a received packet, the recipient determines the CTR value to be used for decrypting the received packet, based on the temporal relationship between another received packet with one value of CTR attached (a first encrypted data) and the received packet in question (a second encrypted data), i.e., the reception order of those packets, and the CTR value attached to the another received packet, and then decrypts the received packet in question using the determined CTR value and the decryption key.

For example, for a 0-th received packet with one value of CTR attached and a n-th received packet with no CTR value attached, the CTR value used for encrypting the n-th received packet can be determined by adding n to the CTR value attached to the 0-th received packet, then the n-th received packet with no CTR value attached can be decrypted using the determined CTR value and the decryption key.

In order to decrypt a received packet with no CTR value attached in this way, it is desirable that a packet with one value of CTR attached and a packet with no CTR value attached are received by a recipient in the transmission order. However, even if the reception order is different from the transmission order, decryption can be attempted using more than one candidate CTR values attached to packets received before or after the received packet in question.

A sender (encrypting party) can select packets to be attached with respective CTR value in any various way. For example, one value of CTR may be attached for every certain number of user data or at regular time intervals. Also, if a sender transmits more than one encrypted packet in one transmission unit, attachment of CTR values can be controlled so that at least one PDU with one value of CTR attached is included in each transmission unit. Furthermore, the position of a packet with one value of CTR attached can be sequentially switched among beginning, middle, and end of burst data for each transmission of burst data.

For example, in the case that more than one encrypted packet (PDU) are contained in (mapped to) a physical (PHY) burst of an OFDMA (or OFDM) radio frame (as an example of the transmission unit) and transmitted, attachment of CTR values can be controlled so that at least one PDU with one value of CTR attached is included in each PHY burst.

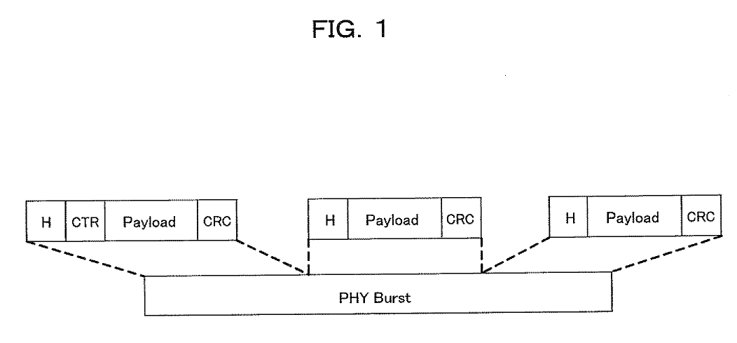

FIG. 1 illustrates an example. In FIG. 1, one PHY burst contains three PDUs, only one (the beginning) of which has one value of CTR attached. Note that a PDU with one value of CTR attached is not limited to a PDU contained in the beginning of a PHY burst. Also, the transmission unit may be an tunnel packet to which more than one PDU are mapped.

Sometimes an error may occur in a packet (PDU) with one value of CTR attached, and a recipient (decrypting party) may not be able to correctly detect the CTR value.

Even in that case, if a recipient has correctly received a packet with one value of CTR attached included in a PHY burst that was received before or after the error packet or both, the recipient can recover the CTR value attached to the error packet based on the correctly received CTR value.

Also, the same CTR value as one attached to the error packet can be retransmitted from the sender to the recipient. The retransmission of the CTR value may be performed in response to an individual request from the recipient, who has detected the error packet, to the sender for the retransmission of the CTR value, or may be performed in response to the sender's receiving the notice indicating the failed reception (NAK (NACK)) from the recipient, without waiting for the retransmission request.

Furthermore, the number of packets to be attached with respective CTR values can be adaptively controlled depending on the fluctuation in channel performance (radio channel quality) between a sender and a recipient. For example, if the radio channel condition is getting worse, the number of packets to be attached with respective CTR values may be controlled to be increased so that, even if errors occur in some packets with their respective CTR values attached, the possibility of being able to recover the CTR value attached to the error packet can be increased based on another packet with its CTR values attached.

Quality indicators for radio channel include Carrier to Interference and Noise Ratio (CINR), Receive Signal Strength Indicator (RSSI), the number of error packets detected by recipient, and the number of occurrence of retransmission requests using Automatic Repeat reQuest (ARQ) or Hybrid ARQ (HARQ).

CINR and RSSI can be determined by a recipient based on a known received signal such as a pilot signal, and can be reported (fed back) to the sender. Then the sender can control the number of packets to be attached with respective CTR values depending on the variance of the feedback information.

If the number of error packets detected by a recipient or the number of occurrence of retransmission requests using ARQ/HARQ increases, the quality of radio channel from the sender to the recipient may be determined (estimated) to be getting worse. Then, for example, the sender can control the number of packets to be attached with respective CTR values based on the number of NAK received in a certain period of time.

Also, Signal to Noise Ratio (SNR) may be used for radio channel quality indicator. Furthermore, in the case that a sender can estimate at a certain confidence the reception quality of a radio channel at a recipient (e.g., the case that Time Division Duplex (TDD) is adopted into a radio link between a sender and a recipient), the radio channel condition described above can be determined autonomously by the sender based on the received signal.

Also, a CTR value can be protected by attaching an error correction code to the CTR value to improve the error resilience of the CTR value itself.

Now, a specific example of a radio communication system to which the above-described encryption/decryption method is applied is described below.

### [B] First Embodiment

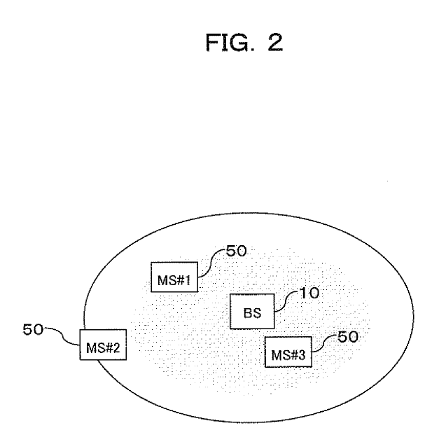

FIG. 2 illustrates an example configuration of a radio communication system in accordance with a first embodiment. In FIG. 2, three mobile stations (user terminals) 50 (MS #1, #2, #3) reside within a radio communication zone (cell) formed by at least one base station (BS) 10, each MS establishing a radio link and communicating with the BS 10. In other words, more than one MS 50 can simultaneously connect to one BS 10 by P-MP connection.

Note that the number of BS 10 and MS 50 is not limited to the one illustrated in FIG. 2. The radio link includes a downlink (DL) radio channel from the BS 10 to the MS 50 and an uplink (UL) radio channel from the MS 50 to the BS 10. Thus, for the DL traffic, the BS 10 corresponds to a transmitter (encryptor) and the MS 50 corresponds to a receiver (decryptor). On the other hand, for the UL traffic, the BS 10 corresponds to a receiver (decryptor) and the MS 50 corresponds to a transmitter (encryptor). These relationships are similar to the below.

Additionally, the radio channels include a common channel shared by more than one MS 50s and individual channels for respective MS 50s, each channel including a control channel for transmitting a control signal, a data channel for transmitting user data, etc.

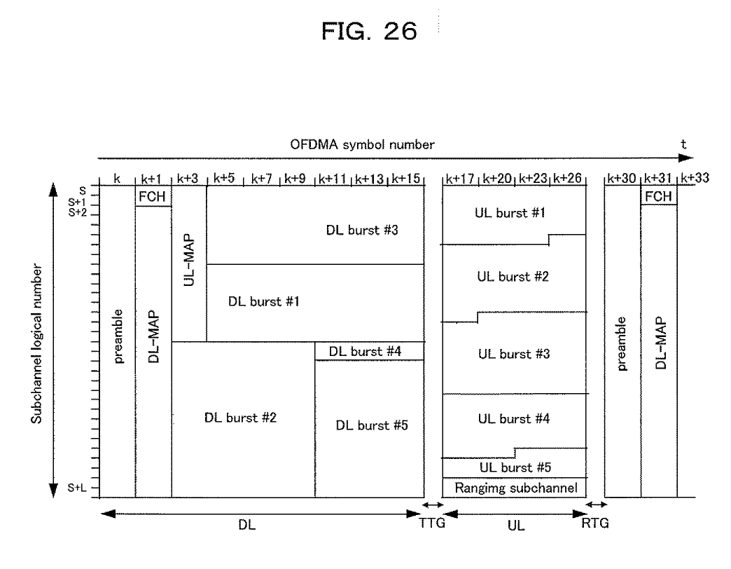

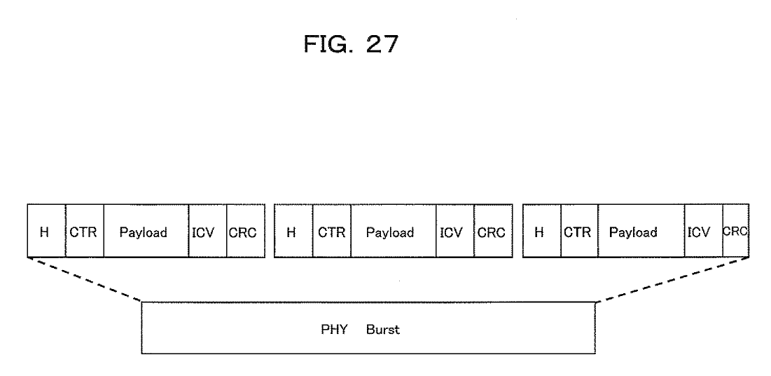

In this embodiment, a communication scheme defined by the 802.16 spec is applied as an example of a radio communication scheme using a radio link. Then, in this embodiment, OFDMA (or OFDM) is applied to the radio communication between the BS 10 and the MS 50, which uses a radio frame illustrated in FIG. 26, for example. However, the encryption/decryption method of this embodiment may also be applied to a communication system using an IP packet described in “Description of Related Art” section.

(b1) About BS

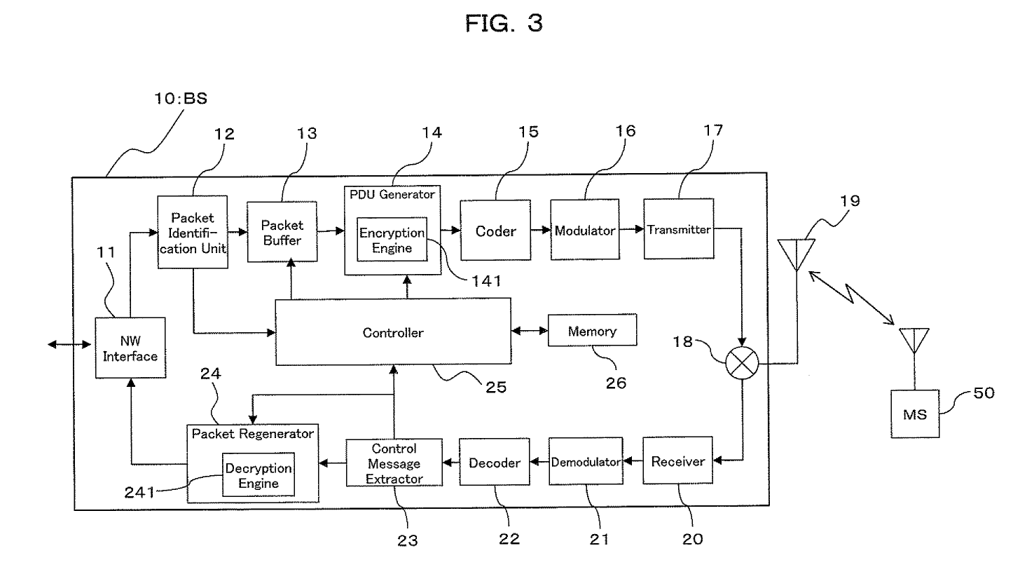

As illustrated in FIG. 3, for example, the BS 10 in this embodiment includes: a network (NW) interface 11; a transmission section (transmission unit; DL processing section) including a packet identification unit 12, a packet buffer 13, a PDU generator 14, a coder 15, a modulator 16, and a transmitter 17; a receiving section (reception unit; UL processing section) including a receiver 20, a demodulator 21, a decoder 22, a control message extractor 23, and a packet regenerator 24; an antenna 19 for transmitting a radio signal to the MS 50 and receiving a radio signal from the MS 50; a duplexer 18 for sharing the antenna 19 between the transmission section and the receiving section; and a control section (control unit) including a controller 25 and a memory 26. Also, dedicated antennas 19 may be provided for the transmission section and the receiving section, respectively.

The NW interface 11 interfaces with a router (not illustrated), connected to more than one BS 10s and for routing data such as packet data, and provides, for example, protocol conversion for packet communication.

The packet identification unit 12 identifies an IP address included in a packet data received from the NW interface 11 and determines a target MS 50 (or its logical connection) based on the IP address. This determination can be done, for example, by storing in a memory in advance the correspondence between an IP address and the identifying information (MS-ID/CID) of a MS 50 (or its logical connection) and retrieving the MS-ID/CID corresponding to an identified IP address. If one MS has only one logical connection, CID has the same meaning as MS-ID.

Additionally, the packet identification unit 12 can store in a memory in advance the correspondence, for example, between a MS-ID (or CID) and a Quality of Services (QoS) information and retrieve the QoS information corresponding to a determined MS-ID (or CID).

Then, the packet identification unit 12 gives the retrieved MS-ID, QoS information, and data size of a received packet to the controller 25 to request bandwidth allocation, and stores the packet data forwarded from the NW interface 11 in the packet buffer 13.

For DL traffic, in response to receiving the bandwidth allocation request from the packet identification unit 12, the controller 25 selects (schedules) a MS 50 to allocate bandwidth based on the QoS information and instructs the packet buffer 13 and PDU generator 14 to transmit user data for the selected MS 50. At this time, if the user data is to be encrypted, the controller 25 notifies the PDU generator 14 of an encryption key and one value of CTR for its encryption.

Also, the controller 25 can generate a control data (hereinafter, also referred to as control signal or control message) for a MS 50. For example, the control data for a MS 50 includes the response message (SBC-RSP: Subscriber Station(SS) Basic Capability—ReSPonse) to a control message (SBC-REQ: Subscriber Station(SS) Basic Capability—REQuest) notifying functions supported by the MS 50 itself. These control data are contained in a PDU by the PDU generator 14 and transmitted to the MS 50, as with the user data.

The PDU generator 14 generates a PDU so that the user data and control data are contained in (mapped to) a radio frame (DL burst) formed with respect to a synchronizing signal (preamble signal), and forwards the PDU to the coder 15. Also, the PDU generator 14 includes an encryption engine 141, and, if the user data is to be encrypted, the PDU generator 14 encrypts the user data using the encryption key and CTR value notified by the controller 25. At this time, the CTR values are selectively attached to the encrypted PDUs respectively. In other words, the CTR values are attached to only some (not all) of the encrypted PDUs respectively.

In the case of mapping more than one PDU to one PHY burst (DL burst), the generated PDUs may be combined with other PDUs into a bit sequence which is input to a randomizer (not illustrated) to be randomized according to a predetermined rule.

The coder 15 codes the PDU obtained from the PDU generator 14 using a predetermined coding scheme. Examples of coding schemes include Forward Error Correction (FEC) coding such as convolution coding, turbo coding, and Low Density Parity Check (LDPC) coding. Also, the coded PDU may be input to a bit-interleaver (not illustrated) to have their bit positions interleaved.

The modulator 16 modulates the coded data obtained from the coder 15 using a predetermined modulation scheme such as QPSK, 16QAM, 64QAM, etc. The modulated signal is mapped, e.g., to sub-channels and symbols constituting the DL burst.

The transmitter 17 carries out radio transmission processing on the modulated signal obtained from the modulator 16, the radio transmission processing including DA conversion, frequency conversion to a predetermined radio frequency (up-conversion), power amplification to a predetermined transmission power, etc. Thus obtained radio signal is transmitted from the antenna 19 to the MS 50 through the duplexer 18.

On the other hand, the receiver 20 carries out radio receiving processing on a UL signal received at the antenna 19 and input to the receiver 20 through the duplexer 18, the radio receiving processing including low-noise amplification, frequency conversion to baseband frequency (down-conversion), AD conversion, etc.

The demodulator 21 demodulates the received signal processed as above using a demodulation scheme paired with the modulation scheme used in the MS 50, such as QPSK, 16QAM, 64QAM, etc. In this demodulation, for example, the received bit sequence of PDUs mapped to the sub-channels and symbols constituting the received UL burst is demapped.

Also, if the received bit sequence has been bit-interleaved as the coded bit sequence for transmission in the MS 50 (the UL sender), the received bit sequence may be input to a bit-deinterleaver (not illustrated) to be deinterleaved using a deinterleave pattern paired with the interleave pattern.

The decoder 22 decodes the received bit sequence demodulated by the demodulator 21 using a decoding scheme paired with the coding scheme used in the MS 50 (FEC coding such as convolution coding, turbo coding, and LDPC coding). Also, if the combined bit sequence of more than one PDU has been randomized by the randomizer in the MS 50 (the UL sender), the received bit sequence decoded may be input to a de-randomizer (not illustrated) to be de-randomized into the original bit sequence.

The control message extractor 23 extracts the control data (e.g., above mentioned SBC-REQ, etc.) from the data decoded by the decoder 22 to give it to the controller 25, and forwards the data other than the control data, such as user data, to the packet regenerator 24.

The controller 25 also performs processing according to the control data received from the control message extractor 23. For example, the controller 25 performs registration and authentication of functions supported by the MS 50, generation and replacement of encryption/decryption key, state management of radio channels, etc. Also, the controller 25 is accessibly (readably/writably) connected with the memory 26. The memory 26 stores various data that must be stored for proper operation of the BS 10. For example, the memory 26 stores information included in the control data received from the MS 50, regarding functions supported by the MS 50, authentication, encryption/decryption key, radio channels, QoS of connection, etc. The memory 26 may also be used to manage and store the usage of resources of the BS 10.

The packet regenerator 24 packetizes the data, other than the control data, forwarded from the control message extractor 23 and forwards it to the NW interface 11. Also, the packet regenerator 24 includes a decryption engine 241 for decrypting an encrypted PDU, and, if the received PDU is encrypted, the packet regenerator 24 obtains the information necessary for decryption from the controller 25.

For example, if no CTR value is attached to the received PDU, the packet regenerator 24 requests the CTR value and decryption key for decrypting the PDU from the controller 25. If one value of CTR is attached to the received PDU, the packet regenerator 24 notifies the controller 25 of the CTR value. The controller 25 manages (stores) decryption keys and CTR values, e.g., in the memory 26, and, in response to receiving a request for a CTR value and decryption key or a notification of a CTR value from the packet regenerator 24, the controller 25 notifies the packet regenerator 24 of the CTR value and decryption key, or the encryption key. The packet regenerator 24 decrypts the encrypted PDU in the decryption engine 241 using the CTR value and decryption key obtained.

(b2) About MS

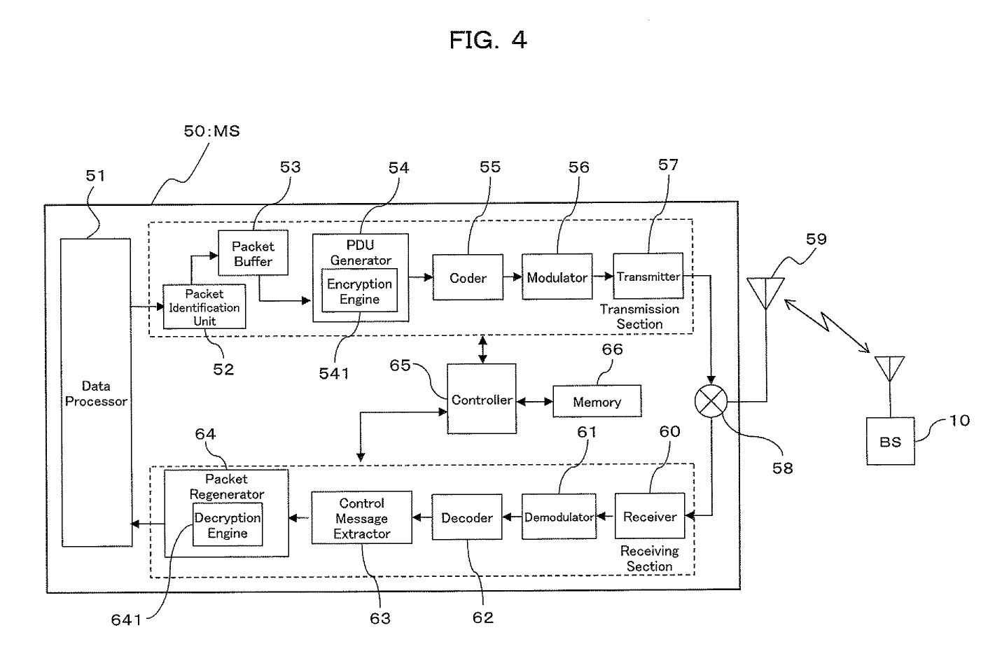

On the other hand, the MS 50 in this embodiment is configured as illustrated in FIG. 4. Specifically, in FIG. 4, the MS 50 includes: a data processor 51; and a transmission section (transmission unit; UL processing section) including a packet identification unit 52, a packet buffer 53, a PDU generator 54, a coder 55, a modulator 56, and a transmitter 57. Also, the MS 50 includes: a receiving section (reception unit; DL processing section) including a receiver 60, a demodulator 61, a decoder 62, a control message extractor 63, and a packet regenerator 64; and a control section (control unit). Furthermore, the MS 50 includes: a controller 65 and a memory 66 as an example of the control section; an antenna 59 for transmitting a radio signal to the BS 10 and receiving a radio signal from the BS 10; and a duplexer 58 for sharing the antenna 59 between the transmission section and the receiving section. Also, dedicated antennas 59 may be provided for the transmission section and the receiving section, respectively.

The data processor 51 includes a transmission data processing capability of generating UL transmission data, such as user data other than control data, to be transmitted to the BS 10 and giving it to the packet identification unit 52, and a received data processing capability of performing processing according to the DL received data, such as user data other than control data, transmitted from the BS 10 to the MS 50 itself. The received data processing capability may include, e.g., processing various data included in the received data for presentation, processing audio output, etc.

The packet identification unit 52 identifies the IP address included in the data (packet) received from the data processor 51 and determines the connection based on the IP address. The determination can be done, for example, by storing in a memory in advance the correspondence between an IP address and a connection identity (CID) and retrieving the CID corresponding to an identified IP address.

Additionally, the packet identification unit 52 can store in a memory in advance the correspondence between a CID and a QoS information and retrieve the QoS information corresponding to a determined connection (CID).

Then, the packet identification unit 52 gives the CID, QoS information, data size, etc. to the controller 65 to request transmission, and stores the packet data from the data processor 51 in the packet buffer 53.

In response to receiving the transmission request from the packet identification unit 52, the controller 65 instructs the packet buffer 53 and PDU generator 54 to perform transmission based on the information of the UL bandwidth allocated by the BS 10. The controller 65 is accessibly (readably/writably) connected with the memory 66. The memory 66 stores various data that must be stored for proper operation of the MS 50. For example, the controller 65 manages (stores) encryption keys and CTR values, e.g., in the memory 66, and, if the user data is to be encrypted, the controller 65 notifies the PDU generator 54 of the encryption key and CTR value for its encryption.

The PDU generator 54 generates a PDU so that the user data and control data are contained in a radio frame (allocated UL burst) formed with respect to a synchronizing signal (preamble signal) to be transmitted by the BS 10, and forwards the PDU to the coder 55. Also, the PDU generator 54 includes an encryption engine 541, and, if the user data is to be encrypted, the PDU generator 54 encrypts the user data in the encryption engine 541, using the encryption key and CTR value notified by the controller 65.

In the case of mapping more than one PDU to one UL burst, as in the case of the transmission section (DL processing section) of the BS 10, the generated PDUs may be combined with other PDUs into a bit sequence which is input to an randomizer (not illustrated) to be randomized according to a predetermined rule.

The coder 55 codes the PDU obtained from the PDU generator 54 using a predetermined coding scheme. Examples of coding schemes include FEC coding such as convolution coding, turbo coding, and LDPC coding, as in the case of the transmission section (DL processing section) of the BS 10. Also, the coded PDU may be input to a bit-interleaver (not illustrated) to have their bit positions interleaved.

The modulator 56 modulates the coded bit sequence obtained from the coder 55 using a predetermined modulation scheme such as QPSK, 16QAM, 64QAM, etc. The modulated signal is mapped to, e.g., sub-channels and symbols constituting the UL burst.

The transmitter 57 carries out radio transmission processing on the modulated signal obtained from the modulator 56, the radio transmission processing including DA conversion, frequency conversion to a predetermined radio frequency (up-conversion), power amplification to a predetermined transmission power, etc. Thus obtained radio signal is transmitted from the antenna 59 to the BS 10 through the duplexer 58.

On the other hand, in the receiving section, the receiver 60 carries out radio receiving processing on a DL signal received at the antenna 59 and input to the receiver 60 through the duplexer 58, the radio receiving processing including low-noise amplification, frequency conversion to baseband frequency (down-conversion), AD conversion, etc.

The demodulator 61 demodulates the received signal processed as above using a demodulation scheme paired with the modulation scheme used in the BS 10, such as QPSK, 16QAM, 64QAM, etc. In this demodulation, for example, the received bit sequence of PDUs mapped to the sub-channels and symbols constituting the received DL burst is demapped.

Also, if the received bit sequence has been bit-interleaved as the coded bit sequence for transmission in the BS 10 (the DL sender), the received bit sequence may be input to a bit-deinterleaver (not illustrated) to be deinterleaved using a deinterleave pattern paired with the interleave pattern.

The decoder 62 decodes the received signal demodulated by the demodulator 61 using a decoding scheme paired with the coding scheme used in the BS 10 (FEC coding such as turbo coding). Also, if the combined bit sequence of more than one PDU has been randomized by the randomizer in the BS 10 (the DL sender), the received bit signal decoded may be input to a de-randomizer (not illustrated) to be de-randomized into the original bit sequence.

The control message extractor 63 extracts the control data (e.g., above mentioned SBC-RSP, etc.) from the data decoded by the decoder 62 to give it to the controller 65, and forwards the data other than the control data, such as user data, to the packet regenerator 64.

The packet regenerator 64 packetizes the data, other than the control data, forwarded from the control message extractor 63 and forwards it to the data processor 51. Also, the packet regenerator 64 includes a decryption engine 641 for decrypting an encrypted PDU, and, if the received PDU is encrypted, the packet regenerator 64 obtains the information necessary for decryption from the controller 65.

For example, if no CTR value is attached to the received PDU, the packet regenerator 64 requests the CTR value and decryption key for decrypting the PDU from the controller 65. If one value of CTR is attached to the received PDU, the packet regenerator 64 notifies the controller 65 of the CTR value. The controller 65 manages (stores) decryption keys and CTR values in, e.g., the memory 66, and, in response to receiving a request for a CTR value and decryption key or a notification of a CTR value from the packet regenerator 64, the controller 65 notifies the packet regenerator 64 of the CTR value and decryption key, or the encryption key. The packet regenerator 64 decrypts the encrypted PDU in the decryption engine 641 using the CTR value and decryption key obtained.

Also, the controller 65 performs processing of control data to transmit to/receive from the BS 10. For example, the controller 65 performs registration and authentication of functions supported by the BS 10, generation and replacement of encryption/decryption key, state management of radio channels, etc. In addition to these processing, the controller 65 generates various control data such as control message (SBC-REQ) for notifying the BS 10 of the functions supported by the MS 50 itself.

Also, the controller 65 controls the transmission section based on the UL bandwidth allocation information (UL-MAP) received from the BS 10, and transmits the user data or control data to BS 10. If the allocation of UL bandwidth is needed, the controller 65 controls the transmission section (the PDU generator 54) so as to generate a Bandwidth Request (BR) header for a connection that needs to be allocated bandwidth and transmit the BR header to the BS 10.

(b3) Description of Operation

Now, the operation of the radio communication system (the BS 10 and MS 50) having above-described functions is described in detail below, focusing on the encryption/decryption processing.

(Negotiation about Ctr Value Omission Capability)

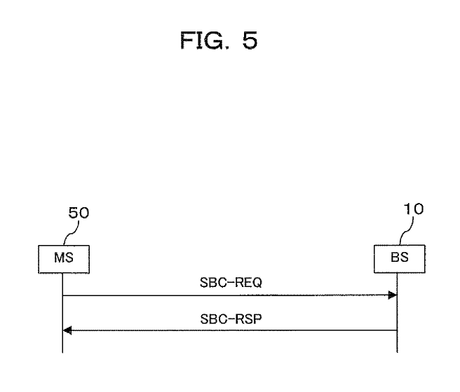

When connecting to the BS 10, the MS 50 notifies the BS 10 of the capability of the MS 50 itself, such as an encryption algorithm supported by the MS 50, etc., before starting the communication. At this time, if a unique value for each packet, such as a counter (CTR) value, is used for the encryption algorithm, the MS 50 can notify (negotiate with) the BS 10 whether it is possible to attach the value to only some packets (PDUs) and omit the value for the other PDUs. For example, as illustrated in FIG. 5, the MS 50 can negotiate whether the CTR value omission capability is supported, using SBC-REQ/SBC-RSP messages.

(Encryption Processing)

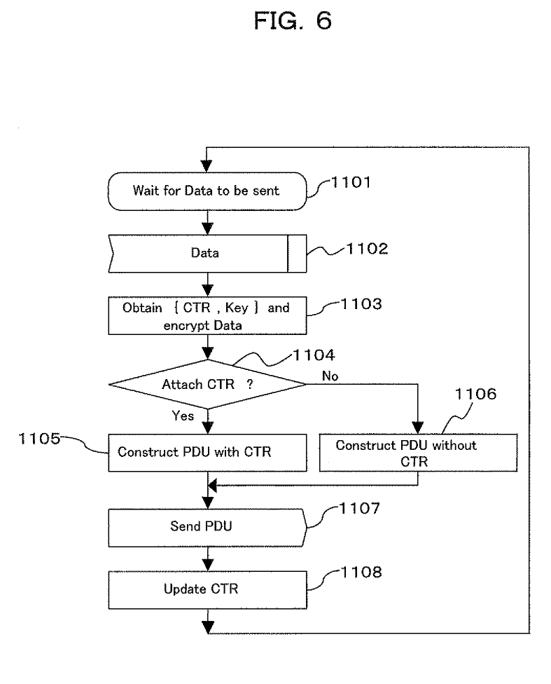

FIG. 6 illustrates an example of encryption processing flow. Note that the encryption processing illustrated in FIG. 6 corresponds to the encryption processing for DL traffic in the BS 10 as well as for UL traffic in the MS 50.

In the BS 10 (MS 50) as an encryptor (transmitter), if user data (e.g., IP packet) to be transmitted is stored in the packet buffer 13 (53), one value of the counter (CTR) and an encryption key necessary for encrypting the user data (user packet) in the encryption engine 141 (541) is retrieved from the memory 26 (66) and given to the encryption engine 141 (541) by the controller 25 (65). User data may include various data such as sound, text, image, video etc. (applicable hereinafter).

For example, in the BS 10, the memory 26 stores and manages encryption keys and CTR values for respective MS 50s, and the controller 25 retrieves a corresponding encryption key and CTR value from the memory 26 based on the attribute information of each user packet (e.g., a header information of an IP packet).

After obtaining the encryption key and CTR value from the controller 25 (65), the encryption engine 141 (541) encrypts the user data using the encryption key and CTR value (steps 1101 to 1103).

At this time, the encryption engine 141 (541) determines whether to attach the CTR value used for encrypting the user data to the encrypted user data and notify that to the MS 50 (BS 10) (step 1104). The criteria by which to determine whether to attach the CTR value may be, for example, whether the number of encrypted packets has reached a certain number, whether a certain period of time has elapsed, etc. This criteria is notified and set by, e.g., the controller 25 (65).

If the CTR value is to be attached as a result of the determination, the PDU generator 14 (54) encapsulates the user packet encrypted by the encryption engine 141 (541), with the header, CTR value, CRC code for bit error detection, and ICV (if message authentication is needed) attached, and generates a PDU (“Yes” in step 1104 to step 1105).

On the other hand, if the CTR value is not to be attached (to be omitted), the PDU generator 14 (54) encapsulates the user data encrypted by the encryption engine 141 (541), with the header, CRC code for bit error detection, and ICV (if message authentication is needed) attached, and generates a PDU (“No” in step 1104 to step 1106).

In this way, the encryptor (encryption engine 141 (541)) of this embodiment selectively attaches to some of the encrypted user data the CTR value used for its encryption.

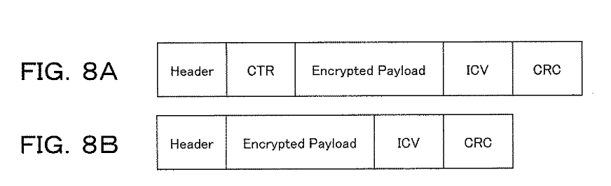

FIG. 8A illustrates an example format of a PDU with one value of CTR attached, while FIG. 8B illustrates an example format of a PDU with no CTR value attached (with one value of CTR omitted). In these formats, it is desirable that a flag indicating whether one value of CTR is attached is set in the header so that the recipient MS 50 (BS 10) can easily detect whether one value of CTR is attached.

Then the generated PDU with one value of CTR attached or with no CTR value attached is transmitted from the antenna 19 (59) to the MS 50 (BS 10) through the coder 15 (55), the modulator 16 (56), the transmitter 17 (57), and the duplexer 18 (58). Also, the encryption engine 141 (541) updates the CTR value by incrementing by 1 (step 1108). Thus the CTR value is a sequential number being incremented by 1 for every encryption of respective user packets, regardless of whether or not the CTR value is attached. It should be noted that incrementing by 1 is only one example, and any other rule for incrementing may be applicable.

(Decryption Processing)

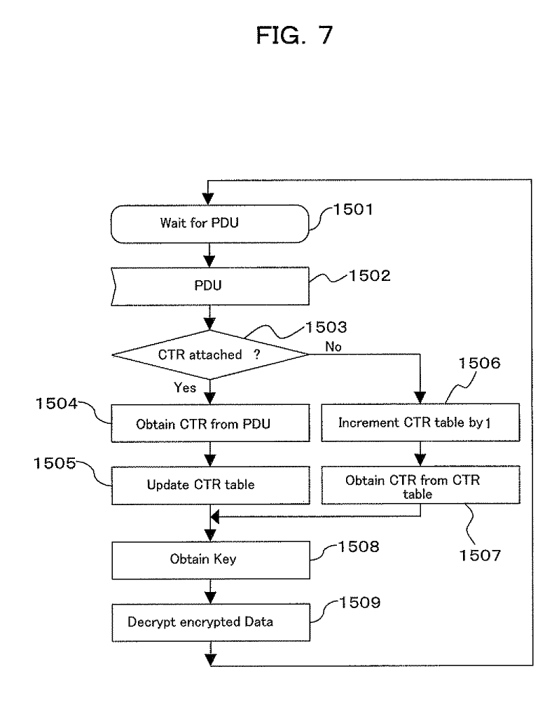

On the other hand, FIG. 7 illustrates an example of decryption processing flow. Note that the decryption processing illustrated in FIG. 7 corresponds to the decryption processing for DL traffic in the MS 50 as well as for UL traffic in the BS 10.

When receiving a user packet (PDU) transmitted by the BS 10 (MS 50) as an encryptor, the MS 50 (BS 10) as a decryptor performs on the PDU in question radio receiving processing, demodulation, decoding in the receiver 20 (60), demodulator 21 (61), and decoder 22 (62), respectively. The decoded PDU is forwarded to the packet regenerator 24 (64) which checks the flag in the header to determine whether the received PDU in question has one value of CTR attached (steps 1501 to 1503).

As a result, if one value of CTR is attached to the received PDU (“Yes” in step 1503), the packet regenerator 24 (64) obtains the CTR value (step 1504) and notify the controller 25 (65) of it. The controller 25 (65) retrieves a decryption key stored and managed by the memory 26 (66), based on the CTR value notified, and notifies the decryption engine 241 (641) of it. Also the CTR value in the CTR table stored and managed by the memory 26 (66) is updated (step 1505).

On the other hand, if no CTR value is attached to the received PDU (“No” in step 1503), the packet regenerator 24 (64) requests the CTR value and decryption key from the controller 25 (65). In response to receiving the request, the controller 25 (65) increments the corresponding CTR value by 1 in the CTR table in the memory 26 (66) (step 1506), retrieves the incremented CTR value (step 1507), retrieves the decryption key from the memory 26 (66), and then notifies the decryption engine 241 (641) of the CTR value and decryption key.

The decryption engine 241 (541) uses the notified CTR value and decryption key to decrypt the encrypted user data (steps 1508 and 1509).

In short, if no CTR value is attached to the received packet, by incrementing the CTR value attached to one packet already received, by 1 for every packet reception, the MS 50 (BS 10) as a decryptor determines the CTR value omitted by the encryptor, based on the reception order of packets and the CTR value used as a reference, and decrypts the received packet with its CTR value omitted, using the determined CTR value and the decryption key.

Note that, in the BS 10 as a decryptor, the controller 25 can store and manage more than one decryption keys and CTR values for respective MS 50s in the memory 26. Specifically, these CTR values and decryption keys are stored and managed in association with CIDs included in the PDU header, respectively, as illustrated in Table 1 and 2 below, for example, and the controller 25 (65) can retrieve both information by looking up the CTR table and decryption key table based on the CID in the PDU header. The same applies to the case that the MS 50 is a decryptor and the MS 50 selectively uses more than one encryption keys.

TABLE 1
CTR Table

| CID | CTR Value |
|---|---|
| #1 | 48237 |
| #2 | 324 |
| #3 | 9387 |
| . | . |
| . | . |
| . | . |

TABLE 2
Decryption Key Table

| CID | Decryption Key |
|---|---|
| #1 | Key#a |
| #2 | Key#b |
| #3 | Key#c |
| . | . |
| . | . |
| . | . |

As have been described above, in accordance with the first embodiment, at the encryptor (transmitter), information the uniqueness of which should be ensured for a certain encryption key (e.g., sequential number (CTR value) being incremented for every encryption) is selectively attached to only some of encrypted data (user packets) and transmitted, enabling the reduction in the quantity of overhead of encrypted packet.

This enables the improvement in throughput of encrypted communication and use efficiency of communication (radio) bands. It is very meaningful that the above-described method provides reduction in the quantity of overhead of encrypted packet in radio (wireless) network the transmission speed in which is generally lower than in wired network.

On the other hand, the decryptor (receiver) determines the CTR value omitted by the encryptor, based on the reception order of packets and the CTR value used as a reference, and decrypts the received packet with its CTR value omitted, using the determined CTR value and the decryption key, enabling correct decryption of the received packet even if its CTR value is omitted.

### [C] Second Embodiment

### Considering PHY Burst

As described in “Description of Related Art” section, in accordance with the 802.16 spec, more than one PDU can be contained in one burst of a radio frame and transmitted. In this case, one value of CTR is desirably attached to at least one PDU included in one burst.

Significant bit errors may occur in a burst of a radio frame due to noise, etc. For example, while the MS 50 is moving, the radio channel condition may change due to shields and reflected waves, which tends to increase bit errors. Also, in the case that an encryptor (transmitter) performs bit-interleaving previously described, even if only some portion of a burst is exposed to noise, all PDUs included in the burst may be affected, and then not all PDUs may be received correctly.

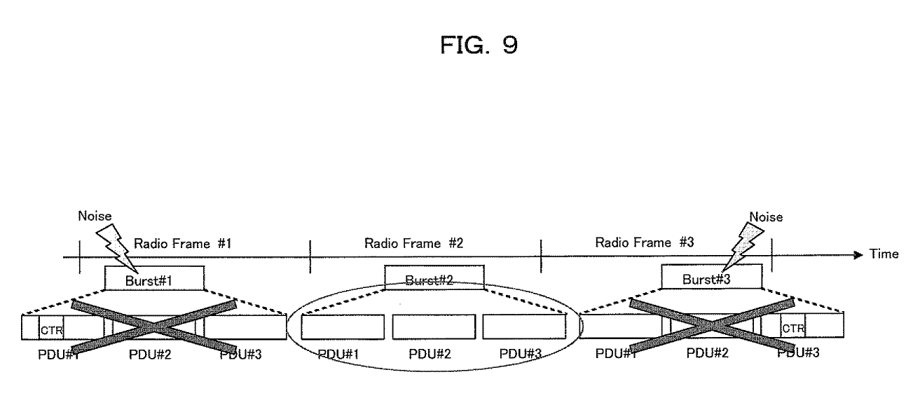

FIG. 9 illustrates an example of an error occurring across a burst. In FIG. 9, a CTR value is attached for every 8 PDUs. Specifically, among three PDUs (#1, #2, and #3) mapped to a burst #1 of a radio frame #1, one value of CTR is attached to the PDU #1. Furthermore, among three PDUs (#1, #2, and #3) mapped to a burst #3 of a radio frame #3, another value of CTR is attached to the PDU #3.

In this case, if high level noise or interference wave, decrease in signal level, etc. occurs in the burst #1 of the radio frame #1 or the burst #3 of the radio frame #3 with the CTR values included, decoding error correction codes may not be able to regenerate the received PDUs correctly. In some cases, even how many PDUs are included in the burst may not be detected.

Thus, if any fault occurs in the burst #1 and #3 including the PDUs with the CTR values attached, it may become difficult to determine the CTR value to be used for decryption for the burst #2, adjacent temporally to the burst #1 and #3, not including any PDU with its CTR value attached, and then it may become difficult to correctly decrypt any encrypted PDU in the burst #2.

In this case, if at least one PDU with one value of CTR attached were included in each burst, the CTR value in the burst #2, which can be received, could be used to correctly decrypt the encrypted PDUs. In this case, the PDU to be attached with one value of CTR may be any PDU mapped to the burst, however, fixedly attaching one value of CTR to the PDU at the beginning of a burst facilitates the determination of CTR values at the decryptor (receiver).

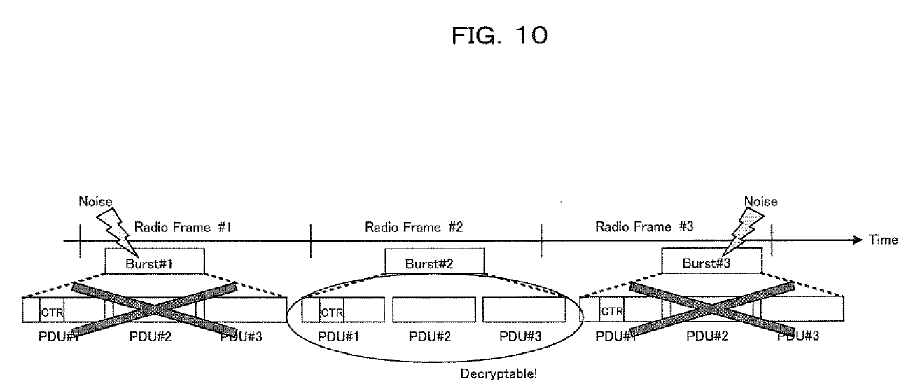

FIG. 10 illustrates an example of a CTR value attached to the PDU at the beginning of a burst. As illustrated in FIG. 10, even if fatal errors occur in bursts #1 and #3, the CTR value attached to a burst #2, which locates temporally between the bursts #1 and #3, can be used to correctly decrypt PDUs mapped in the burst #2.

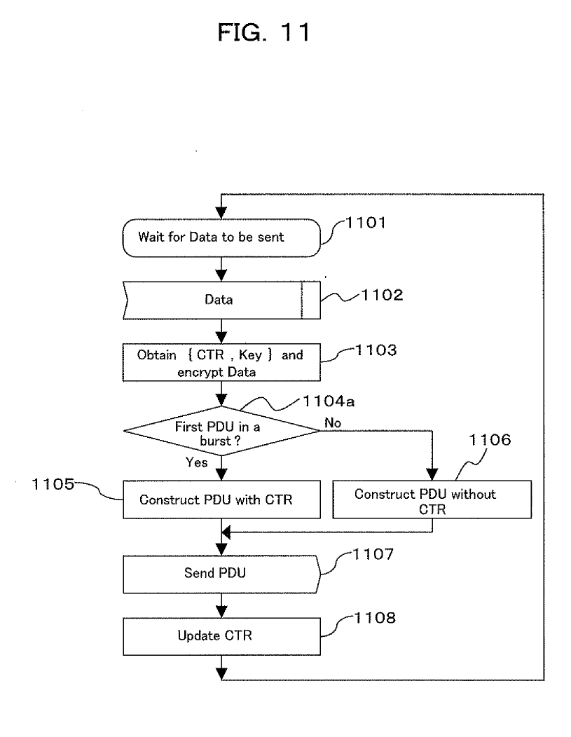

FIG. 11 illustrates an example of encryption processing flow of the encryptor (the BS 10 for DL traffic, the MS 50 for UL traffic) in this embodiment. Configuration of the BS 10 and MS 50 may be similar to that of the first embodiment (FIGS. 3 and 4). Also, a decryption processing flow in the decryptor (the BS 10 for UL traffic, the MS 50 for DL traffic) may be similar to that of FIG. 7.

In the encryptor of this embodiment, the conditional determination of whether to attach a CTR value (step 1104a) is different from that of the first embodiment (FIG. 6). The other steps are the same as the steps 1101 to 1103 and 1105 to 1108 described with reference to FIG. 6, unless otherwise stated.

Specifically, the encryptor (the PDU generator 14 (54)) of this embodiment determines whether a user packet encrypted by the encryption engine 141 (541) is a PDU to be mapped to (the beginning of) a different burst (step 1104a).

As a result of the determination, if the encrypted user packet is a PDU that meets the above condition (e.g., a PDU to be mapped to the beginning of the burst), the PDU generator 14 (54) determines to attach a CTR value (“Yes” in step 1104a); if the encrypted user packet is a PDU that does not meet the above condition (e.g., a PDU to be mapped to any location of the burst other than the beginning thereof), the PDU generator 14 (54) determines to attach no CTR value (“No” in step 1104a). Example formats of a PDU with one value of CTR attached and a PDU with no CTR value attached are as illustrated in FIGS. 8A and 8B, respectively.

Furthermore, if a mixture of more than one PDU encrypted using different encryption keys respectively is mapped to one burst (e.g., if, in the DL direction, more than one PDU corresponding to different MS 50s respectively are mapped to one burst), the determination of whether it is the first PDU in the burst may be performed for each encryption key. This is because a CTR value is defined for one encryption key.

### [D] Third Embodiment

### Operation Depending on Radio Channel Condition

An encryptor may also additionally increase the frequency of attaching the above described CTR value depending on radio link (radio channel) condition.

Consider UL traffic transmitted by the MS 50, for example. The MS 50 determines the condition of the radio channel between the BS 10 and itself by, e.g., measuring the CINR based on a received pilot signal etc., and notifies the BS 10 of (feeds back to the BS 10 on) the Channel Quality Indicator (CQI) corresponding to the measurement.

Based on the notified information indicating the radio channel condition, the BS 10 can adaptively determine (select) a modulation/coding scheme to use and allocate a UL band to the MS 50. For example, when the radio channel condition is good, the BS 10 can select a modulation/coding scheme with high throughput, while, when the radio channel condition is bad, the BS 10 can select a modulation/coding scheme with good error-resilience.

In this case, some delay may occur between the time at which the MS 50 measures the radio channel condition and the time at which the BS 10 actually allocate a UL band to the MS 50. The radio channel condition may change during this delay. Improvement in radio channel condition is no problem, while degradation in radio channel condition may have an adverse affect such as increase in bit error rate.

In view of the above, an encryptor in this embodiment adaptively controls the frequency of attaching a CTR value depending on the radio channel condition. Then, even if a bit error is detected in a PDU with a CTR attached, the decryption of the other PDUs can be easily supported.

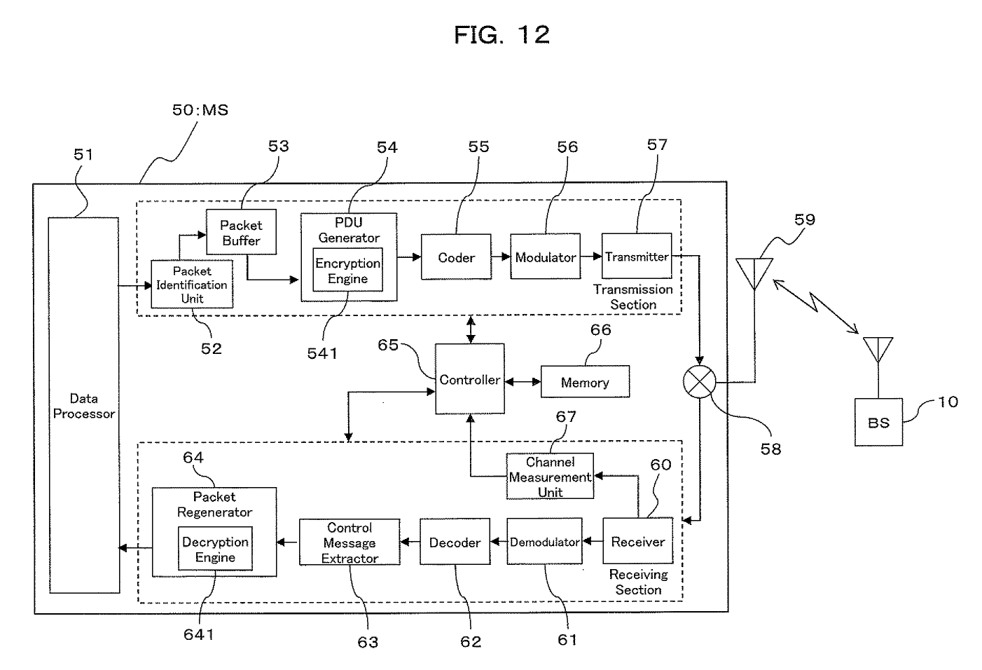

FIG. 12 illustrates an example configuration of the MS 50 as an encryptor of this embodiment.

The MS 50 in FIG. 12 is different from the MS 50 in FIG. 4 in that a channel measurement unit 67 is added. The other elements in FIG. 12 having the same reference numerals as previously described are elements that are the same as or similar to the elements previously described, unless otherwise stated.

The channel measurement unit 67 measures information indicating radio channel condition (channel performance) (such as CINR, RSSI, etc. of a signal received by the receiver 60) (hereinafter, also referred to as channel performance information) and notifies the controller 65 of the channel performance information.

On receiving a channel performance information request from the BS 10, or autonomously, the controller 65 notifies the BS 10 of (feeds back to the BS 10 on) the channel performance information (notified by the channel measurement unit 67) as one of the control messages including CQI etc. Furthermore, after the controller 65 notifies the BS 10 of the channel performance information once, if the controller 65 detects that the channel performance information measured by the channel measurement unit 67 is getting worse, the controller 65 instructs the PDU generator 54 (encryption engine 541) to increase the frequency of attaching a CTR value to a PDU to be transmitted to the BS 10 by the MS 50.

Also, for DL traffic transmitted by the BS 10, adaptive control of the frequency of attaching a CTR value depending on channel performance information is made possible by providing a similar mechanism to the BS 10. In this embodiment, CINR and RSSI are used as an example of channel performance information, however, it should be noted that some other information may also be used. For example, the frequency of detecting NAK information (receiving failure) of ACK/NAK information of ARQ/HARQ notified by the control message extractor 63 (occurrence rate of retransmission request) may be used. Or, the frequency of detecting CRC error of a received PDU in the packet regenerator 64 may be used. In these cases, the channel performance information can be easily converted to a numerical form by monitoring the frequency of detecting NAK information or CRC error in the controller 65.

For example, if the occurrence rate of NAK information or CRC error increases, the radio channel condition may be estimated to be getting worse, and the frequency of attaching a CTR value may be controlled to be increased.

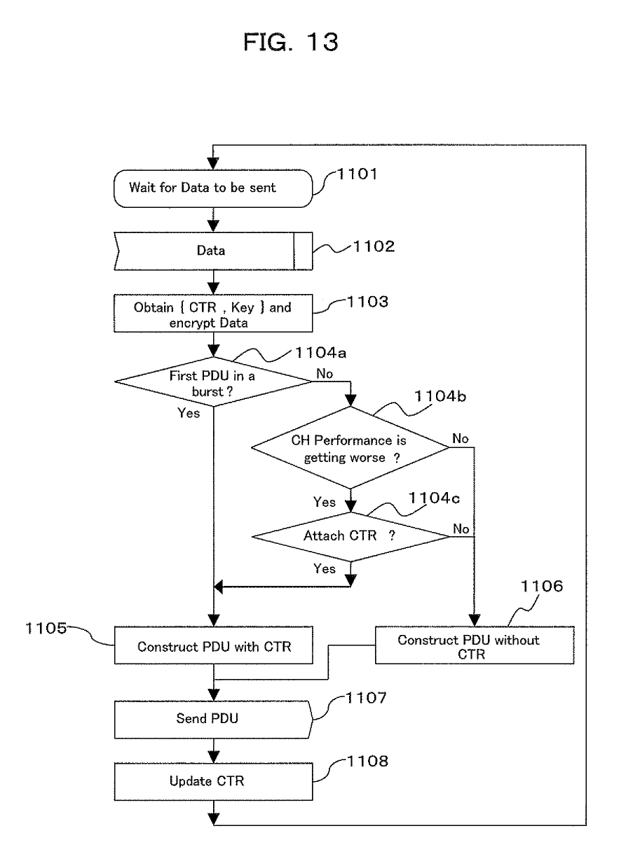

FIG. 13 illustrates an example of encryption processing flow in accordance with this embodiment. Also in this embodiment, an encryptor corresponds to the BS 10 for DL traffic as well as the MS 50 for UL traffic. A decryption processing flow of a decryptor in this embodiment may be similar to that in the first and second embodiment.

In the encryption processing flow illustrated in FIG. 13, the steps 1104b and 1104c for determining whether to attach a CTR value to a PDU other than the PDU at the beginning of a burst based on the information indicating radio channel performance (channel performance information) are applied in addition to the determination step 1104a applied to the encryption processing flow illustrated in FIG. 11 (the second embodiment). Therefore, the steps in FIG. 13 whose reference numerals are the same as in FIG. 11 are the same as or similar to the steps described with reference to FIG. 11, unless otherwise stated.

Specifically, in the encryptor of this embodiment, if a user packet encrypted by the encryption engine 141 (541) is not a PDU to be mapped to the beginning of a different burst (“No” in step 1104a), the controller 25 (65) determines whether the channel performance information measured by the channel measurement unit 67 of the decryptor and notified by the decryptor is getting worse than before (step 1104b).

As a result, if the channel performance information is getting worse (“Yes” in step 1104b), the controller 25 (65) determines whether it is necessary to attach an additional CTR value to any of the PDUs to be mapped to the position other than the beginning of the burst (step 1104c); if necessary (“Yes” in step 1104c), the controller 25 (65) instructs the PDU generator 14 (54) to attach an additional CTR value to the PDU other than the PDU at the beginning of the burst (“Yes” in step 1104b and “Yes” in step 1104c).

On the other hand, if the channel performance information is not getting worse (“No” in step 1104b), or if it is not necessary to attach an additional CTR value to any of the PDUs to be mapped to the position other than the beginning of the burst even though the channel performance information is getting worse (“No” in step 1104c), the controller 25 (65) determines not to attach a CTR value and does not instruct the PDU generator 14 (54) to attach an CTR value, as in the second embodiment.

Note that the determination of whether it is necessary to attach a CTR value may be performed, for example, based on the threshold evaluation of fluctuation level of channel performance information. That is, if the degradation level of channel performance information is higher than or equal to a certain threshold, it may be determined that attaching an additional CTR value is necessary; otherwise, it may be determined that attaching an additional CTR value is not necessary. Again, in this embodiment, example formats of a PDU with one value of CTR attached and a PDU with no CTR value attached are as illustrated in FIGS. 8A and 8B, respectively.

As have been described above, in accordance with this embodiment, the number or ratio of PDUs to be attached with a CTR value can be controlled adaptively depending on the radio channel condition. For example, if the radio channel condition is getting worse, the number of PDUs to be attached with a CTR value can be controlled to be increased.

Therefore, even if an error occurs in one PDU with one value of CTR attached, it is possible to increase the probability of being able to determine the CTR value to be used for decrypting the PDU in which the error occurs, based on a CTR value attached to another PDU, which stochastically increases the number of PDUs that can be correctly decrypted.

Above described channel performance information is measured and notified to the encryptor by the decryptor, but in the case that the encryptor at the sender can autonomously estimate (measure) channel performance information based on a signal received from the decryptor (for example, in the case that Time Division Duplex (TDD) scheme is used for the radio link between the encryptor and decryptor), channel performance information can be measured by the encryptor.

Also, the encryptor can monitor the number of received retransmission request using ARQ/HARQ from the decryptor, and control the number of PDUs to be attached with a CTR value depending on the increase/decrease in retransmission rate. For example, if the retransmission rate increases, the radio channel condition can be determined to be getting worse, then the number of PDUs to be attached with a CTR value can be controlled to be increased.

Furthermore, the transmission interval of PDUs with respective CTR values attached can be controlled depending on the fluctuation of channel performance information. For example, if channel performance information is getting worse, the transmission interval of PDUs with respective CTR values attached can be decreased.

Also, if an additional CTR value is to be attached to a PDU other than the PDU at the beginning of a burst, the number of bits of the additional CTR value may be smaller than that of the CTR value attached to the PDU at the beginning.

For example, if a CTR value to be attached to the PDU at the beginning is defined to be 32 bit, an additional CTR value attached to a PDU other than the PDU at the beginning may be fallen back into 16 bits or 8 bits.

By doing this, even if an additional CTR value is attached to a PDU other than the PDU at the beginning because of radio channel quality getting worse, it is possible to increase the possibility of being able to correctly decrypt a PDU with no CTR value attached at the decryptor, while minimizing the increase in the quantity of overhead of PDUs.

### [E] Fourth Embodiment

### Operation when an Error Occurs in a CTR Value

A fourth embodiment illustrates in more detail the operation when a bit error is detected in a user packet (PDU) with a CTR value attached.

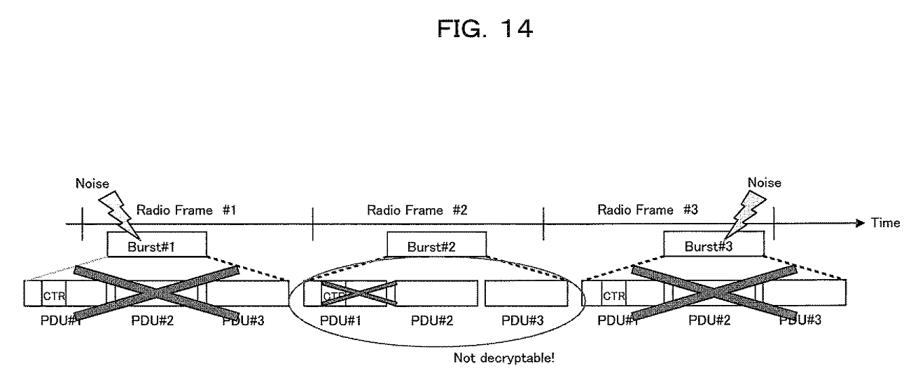

FIG. 14 illustrates a scenario image of a target situation of this embodiment. FIG. 14 illustrates that, in the situation illustrated in FIG. 10, a bit error is detected in the PDU with one value of CTR attached, mapped to the beginning of the burst #2 of the radio frame #2. Note that a bit error can be detected, e.g., using CRC.

In this case, the decryptor (receiver) can successfully receive the PDUs #2 and #3 of the burst #2, but can not decrypt these two PDUs due to failing to receive the CTR value attached to the PDU #1 of the burst #2.

Since a Block Sequence Number (BSN) to be used in a reception response (ACK/NAK information) of ARQ for controlling retransmission is encrypted as a part of a PDU payload, the receiver can not notify the transmitter (encryptor) of which BSN has been successfully received. As a result, the transmitter (encryptor) retransmits the PDUs #2 and #3 which has already been successfully received by the receiver.

The CTR value attached to the packet to be retransmitted using ARQ becomes different from the one attached to the original packet. Therefore, even if the PDU #1 retransmitted by the transmitter is successfully received by the receiver, the CTR value attached to the retransmitted PDU #1 is different from the one attached to the PDU #1 in which an error occurred, then it is difficult to correctly determine the CTR values to be used for the PDU #2 and #3 that have been already received, respectively, which makes the correct decryption of the PDU #2 and #3 difficult.

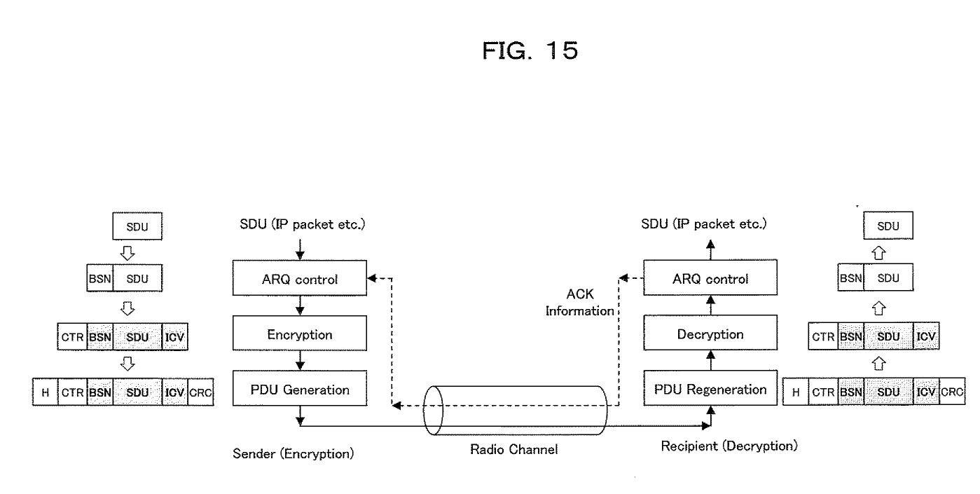

This situation is described in more detail with reference to FIG. 15. FIG. 15 illustrates a conceptual diagram of an ARQ control architecture. As illustrated in FIG. 15, in the sender (encryptor), a user data such as an IP packet (Service Data Unit (SDU)) is forwarded to an ARQ controller.

In the ARQ controller, a BSN is attached to the SDU so that the recipient (decryptor) can feed back the acknowledgment which SDU has been successfully received. Then the SDU with the BSN attached is forwarded to the encryption engine which attaches a CTR value and ICV and encrypts the SDU etc. Then the encrypted SDU is further combined with a header and CRC into a PDU which is transmitted to a radio channel.

On the other hand, the recipient (decryptor) extracts the SDU by performing the inverse processing to the one performed by the sender. At this time, the recipient can notify the sender that the SDU in question has been successfully received, by feeding back the BSN attached to the SDU to the sender. If the SDU has not been successfully received (e.g., a discontinuous BSN has been received), the recipient can request the retransmission of the SDU that has not been received, by transmitting NAK information including the missing BSN(s) to the sender.

Here, the relation between ARQ and encryption will be explained.

A BSN is a sequence number unique to each SDU, and its value does not change when the corresponding SDU is retransmitted. On the other hand, the encryption engine simply encrypts a SDU with a BSN attached forwarded from the ARQ controller, and does not determine whether the SDU in question is to be retransmitted. Therefore, the encryption engine always uses a new value of CTR to perform encryption.

As a result, even if the same SDU is to be retransmitted using ARQ mechanism, a CTR value attached to the SDU to be retransmitted would be different from the CTR value attached to the transmitted SDU of which retransmission has been requested.

Therefore, in FIG. 14, even if the SDU included in the PDU #1 of the radio frame #2 is retransmitted using ARQ control, since the CTR value attached to the PDU including the SDU retransmitted is different from the CTR value attached to the PDU in which the error has occurred, it is difficult to decrypt the PDUs #2 and #3 of the radio frame #2 using the CTR value attached to the PDU retransmitted.

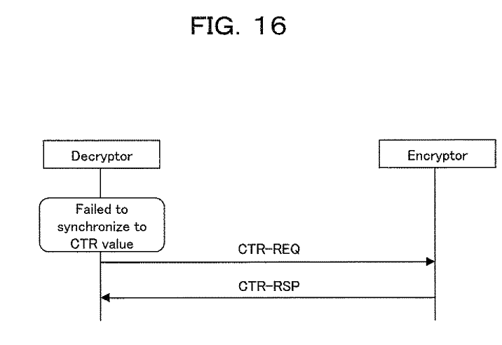

In this embodiment, retransmission of a CTR value is performed in such a scenario. FIG. 16 illustrates an example of retransmission sequence of a CTR value.

As illustrated in FIG. 16, if the decryptor fails in synchronizing to a CTR value due to, e.g., a bit error, the decryptor requests retransmission of the CTR value from the encryptor (Transmission of CTR-REQ message). The CTR-REQ message notifies the encryptor of the fact that the CTR value used for the encryption is unknown, and, if a PDU has been successfully received, the CTR-REQ message also notifies the number of the radio frame including the PDU.

In the case that the logical connection between the encryptor and decryptor is an ARQ-enabled connection, the information indicating the success/failure of reception at the decryptor (ARQ-ACK/NAK) is transmitted from the decryptor to the encryptor, which is not illustrated in FIG. 16.

In response to receiving the CTR-REQ message from the decryptor, the encryptor transmits to the decryptor the CTR value used for encrypting the PDU at the beginning of the burst of the radio frame specified (Transmission of CTR-RSP message).

Table 3 below illustrates an example of the contents of a CTR-REQ message, and Table 4 below illustrates an example of the contents of a CTR-RSP message.

TABLE 3
CTR-REQ Message

| | Field | |
|---|---|---|
| Field Name | Length | Value |
| Management Message Type | 8 bits | 100 |
| Frame Number | 8 bits | Radio Frame No. |
| Burst Index | 8 bits | Burst Index |
| CID | 16 bits | Connection ID |

TABLE 4
CTR-RSP Message

| | Field | |
|---|---|---|
| Field Name | Length | Value |
| Management Message | 8 bits | 101 |
| Type | | |
| Frame Number | 8 bits | Radio Frame No. |
| Burst Index | 8 bits | Burst Index |
| CID | 16 bits | Connection ID |
| CTR | 32 bits | Counter Value |

In Tables 3 and 4, Control Message Type of CTR-REQ and CTR-RSP messages are expressed as “100” and “101”, respectively, as an example.

Also, in the example illustrated in Table 3, the CTR-REQ message includes: the CID of a PDU of which CTR value has not been able to be obtained due to e.g., a bit error; the index of the burst including the PDU (information indicating the temporal order in the radio frame of the burst); and the number of the radio frame transmitting the burst. Thus the CTR-REQ message includes identifying information that allows the encryptor to identify the PDU in which an error occurred. Other information that can identify the encryption/decryption keys shared between the encryptor and decryptor, such as Security Association ID, may also be used in place of the CID.

On the other hand, in the example illustrated in Table 4, the CTR-RSP message further includes the CTR value requested by the CTR-REQ message, in addition to the information included in the CTR-REQ message illustrated in Table 3. This CTR value has been attached to the PDU at the beginning among the PDUs having the same CID included in the burst specified by the radio frame number and burst index.

These CTR-REQ/RSP messages are generated by the controller 25 (65) as one of control signals, processed by the PDU generator 14 (54), the coder 15 (55), the modulator 16 (56), and the transmitter 17 (57), respectively, and transmitted from the antenna 19 (59) through the duplexer 18 (58).

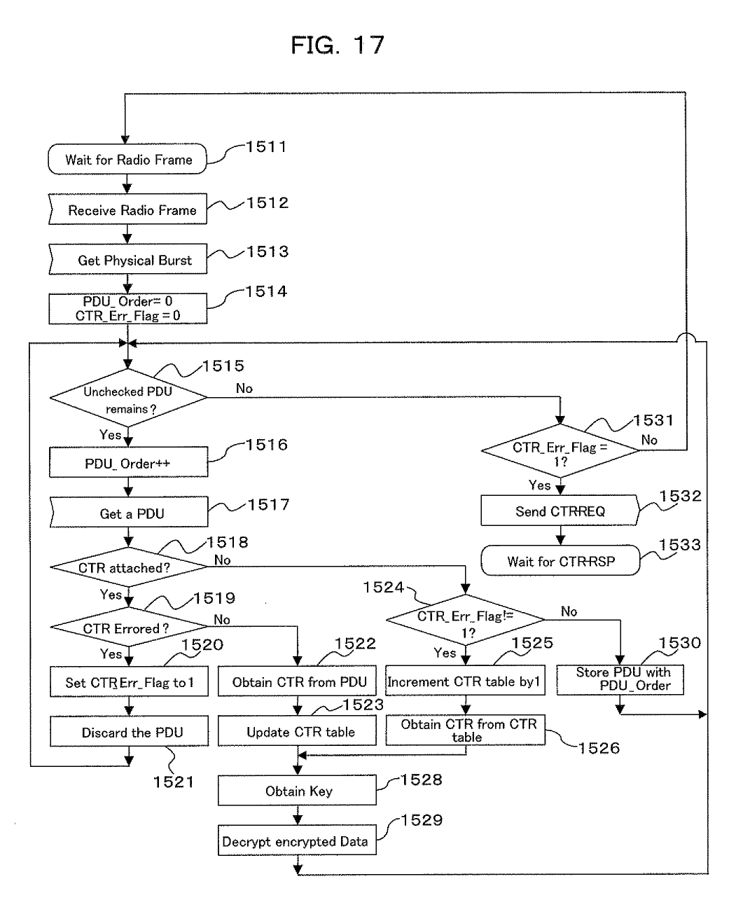

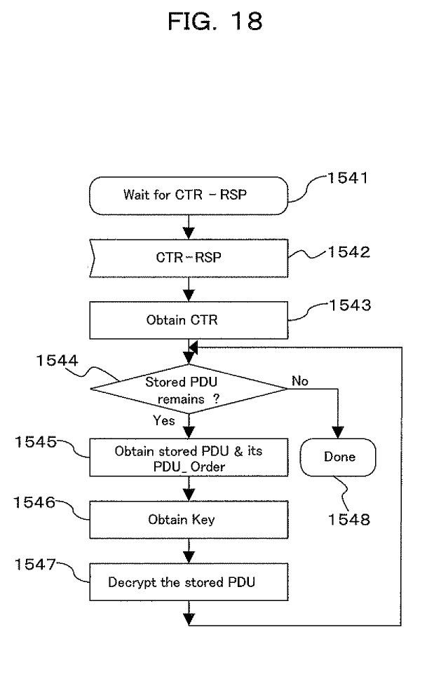

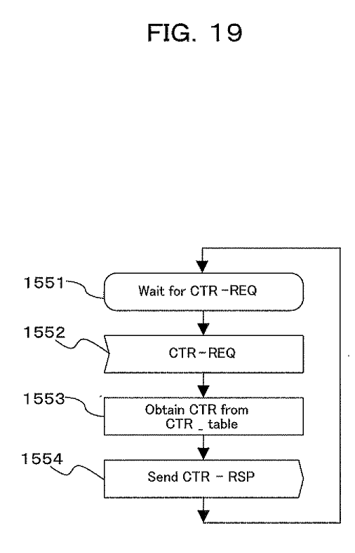

Now, the encryption processing in the encryptor and the decryption processing in the decryptor in accordance with this embodiment are described below in detail with reference to FIGS. 17 to 19. FIGS. 17 and 18 illustrate an example of decryption processing flow of the decryptor of this embodiment, including the synchronization processing of a CTR value described above. FIG. 19 illustrates an example of encryption processing flow of the encryptor of this embodiment. These processings illustrated in FIG. 17 to 19 are performed mainly by, e.g., the controller 25 (65) and packet regenerator 24 (64) in cooperation.

(Decryption Processing)

As illustrated as an example in FIG. 17, the decryptor (the MS 50 for DL traffic, the BS 10 for UL traffic) receives a radio frame from the encryptor (the BS 10 for DL traffic, the MS 50 for UL traffic) and performs processing including the demodulation of a burst included in the radio frame, the decoding of an error correction code, etc. (steps 1511 to 1513).

Then the decryptor performs a different processing for each received PDU depending on whether a CTR value is attached. As a preparation, for example, the decryptor initializes two types of variables: PDU order information (PDU_Order) and CTR error flag (CTR_Err_Flag) (PDU_Order=0, CTR_Err_Flag=0: step 1514). Note that these variables may be managed by either the packet regenerator 24 (64) or the controller 25 (65).

Then the decryptor checks whether any PDU remains unchecked the presence/absence of its attached CTR value among the PDUs mapped to the received burst (step 1515).

If an unchecked PDU remains (“Yes” in step 1515), the decryptor increments the PDU order information (PDU_Order) by 1, and checks whether the unchecked PDU in question is attached with a CTR value (steps 1516 and 1517).

As a result of the check, for example, if the PDU is attached with a CTR value (“Yes” in step 1518), the decryptor checks whether a bit error exists in the CTR value, using e.g., CRC (step 1519).

Then, if a bit error exists in the CTR value (“Yes” in step 1519), the decryptor sets the CTR error flag ((CTR_Err_Flag) to 1 (step 1520), discards the PDU attached with the CTR value in which the bit error in question occurred (step 1521), and returns to step 1515.

On the other hand, as a result of the CRC check, if no bit error exists in the CTR value (“No” in step 1519), the decryptor (e.g., the controller 25 (65)) obtains the CTR value from the PDU with the CTR value in question attached, and updates the previously described CTR table using the CTR value (steps 1522 and 1523).

Then the decryptor (the decryption engine 241 (641)) obtains a decryption key from the controller 25 (65) (step 1528), and decrypts the encrypted PDU using the CTR value and decryption key (step 1529).

On the other hand, if no CTR value is attached to the PDU in step 1518, the decryptor checks the status of the CTR error flag (CTR_Err_Flag) (“No” in step 1518 to step 1524).

As a result, if the CTR error flag (CTR_Err_Flag) is not set, i.e., CTR_Err_Flag=0 (≠1) (“Yes” in step 1524), the decryptor updates the CTR table by incrementing the CTR value in the CTR table by 1 (steps 1525 and 1526).

Then the decryptor (the decryption engine 241 (641)) obtains the updated CTR value and a decryption key from the controller 25 (65) (step 1528), and decrypts the encrypted PDU using the updated CTR value and decryption key (step 1529).

On the other hand, if the CTR error flag (CTR_Err_Flag) is set, i.e., CTR_Err_Flag=1 (“No” in step 1524), the decryptor stores the PDU and the PDU order information (PDU_Order) indicating the temporal order in the burst of the PDU, to, e.g., the memory 26 (66) (step 1530). Note that a PDU order information (PDU_Order) can be managed for each CID.

When the processing for PDUs included in the burst is finished (if “No” in step 1515), the decryptor checks the status of the CTR error flag (CTR_Err_Flag) (step 1531). Then, if the CTR error flag (CTR_Err_Flag) is set, i.e., CTR_Err_Flag=1 (“Yes” in step 1531), the decryptor transmits a CTR-REQ message to the encryptor (step 1532), and waits for the response from the encryptor (CTR-RSP message) (step 1533).

FIG. 19 illustrates an example of processing from waiting for the CTR-REQ message to transmitting the CTR-RSP message performed by the encryptor.

As illustrated in FIG. 19, on receiving the CTR-REQ message from the decryptor (steps 1551 and 1552), the encryptor looks up an CTR management table (stored in the memory 26 (66), for example) illustrated as an example in Table 5 below, based on information such as radio frame number, burst index, and CID included in the message in question, and retrieves a corresponding CTR value (step 1553).

TABLE 5
CTR Management Table

| Radio Frame | Burst | | |
|---|---|---|---|
| No. | Index | CID | CTR |
| 432 | 1 | 42 | 535 |
| | | 765 | 9867 |
| | 2 | 56 | 31 |
| . | . | . | . |
| . | . | . | . |
| . | . | . | . |

Then, in the encryptor, the CTR-RSP message including the retrieved CTR value is generated by, e.g., the controller 25 (65), and transmitted from the antenna 19 (59) to the decryptor through the PDU generator 14 (54), the coder 15 (55), the modulator 16 (56), and the transmitter 17 (57) (step 1554).

FIG. 18 illustrates an example of processing from waiting for the CTR-RSP message to receiving the CTR-RSP message from the encryptor and decrypting the encrypted PDU that has been received, performed by the decryptor.

As illustrated in FIG. 18, when the decryptor receives the CTR-RSP message from the encryptor during waiting for the CTR-RSP message (steps 1541 and 1542), the control message extractor 23 (63) obtains the CTR value included in the message in question (step 1543).

Then, the decryptor checks whether any stored PDU remains to be decrypted (step 1544). If it remains (“Yes” in step 1544), the decryptor retrieves the stored PDU and a corresponding PDU order information (PDU_Order) in the burst, and regenerates the CTR value corresponding to the PDU in question, based on the stored PDU, the PDU order information, and the CTR value obtained from the CTR-RSP message (step 1545).

That is, since the CTR value obtained from the CTR-RSP message is the same as the CTR value of the PDU at the beginning of the burst, and the PDU order information (PDU_Order) indicates the temporal order in the burst of the PDU in question, the CTR value of the PDU in question can be determined by (the received CTR value)+(PDU_Order−1).

Then the decryptor (the decryption engine 241 (641)) obtains a decryption key from the controller 25 (65) (step 1546), and decrypts the encrypted PDU that has been already received and stored to be decrypted, using the decryption key in question and the regenerated CTR value (step 1547).

The decryptor repeats above-described steps 1545 to 1547 until no stored PDU remains (until “No” in step 1544), and terminates the decryption processing when no stored PDU remains (step 1548).

As have been described above, in accordance with this embodiment, even if an error occurred in a PDU with a CTR value attached, the decryptor can obtain the CTR value that was attached to the PDU in which the error occurred, by transmitting to the encryptor a CTR-REQ message to request the retransmission of the CTR value, then the decryptor can ensure the consistency of the CTR value between the encryptor and decryptor (can establish the resynchronization with the CTR value) to correctly decrypt the received PDU that is encrypted.

### [F] Fifth Embodiment

### Automatic Transmission of CTR Value when Receiving NAK

In the fourth embodiment described above, the decryptor explicitly requests the retransmission of (or resynchronization with) a CTR value from the encryptor by transmitting a CTR-REQ message to the encryptor. This requires a radio resource (band) for transmitting the CTR-REQ message from the decryptor to the encryptor.

In view of this, in this embodiment, in response to receiving an ARQ retransmission request (ARQ-NAK) from the decryptor, the encryptor transmits to the decryptor the same CTR-RSP message including a CTR value as in the fourth embodiment described above. This allows the decryptor to establish resynchronization with a CTR value without transmitting to the encryptor a CTR-REQ message to request retransmission of the CTR value, enabling the saving in radio resource (band).

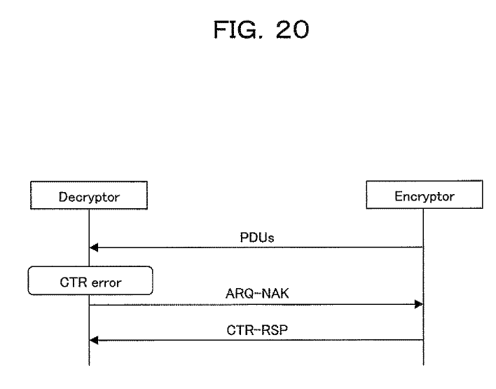

FIG. 20 illustrates an example of retransmission sequence of a CTR value by receiving NAK.

As illustrated in FIG. 20, in response to receiving an ARQ-NAK transmitted by the decryptor due to the occurrence of an error in a CTR value at the decryptor, the encryptor generates the CTR-RSP message for retransmitting the CTR value and sends it to the decryptor.

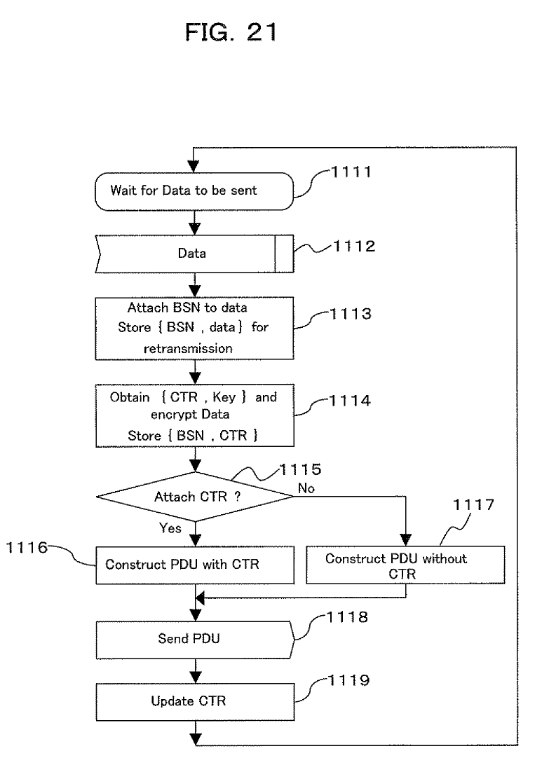

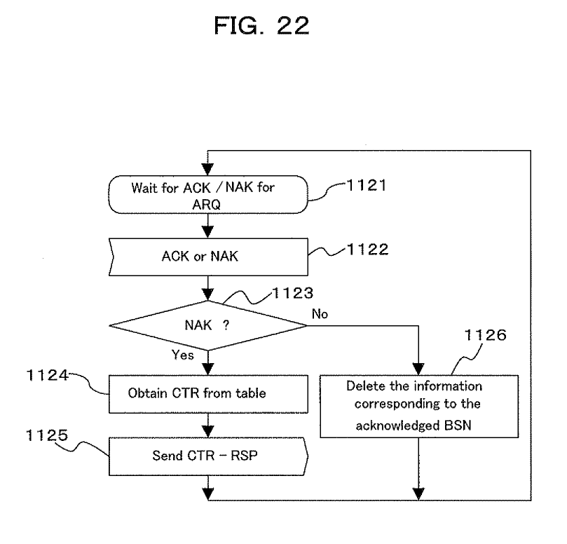

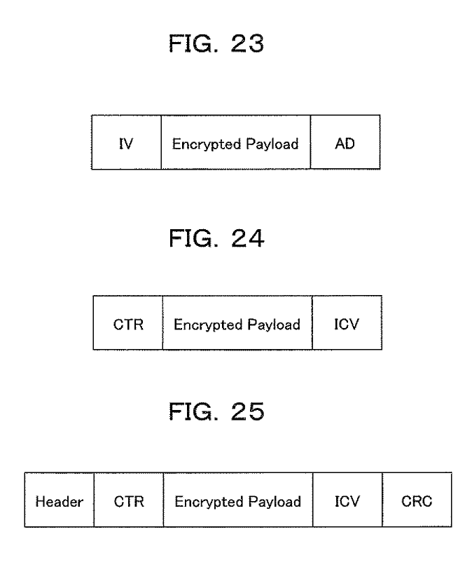

FIGS. 21 and 22 illustrate an example of operation flow of the encryptor for providing such a retransmission sequence. FIG. 21 illustrates an example of operation flow of the encryptor when transmitting data, and FIG. 22 illustrates an example of operation flow of the encryptor when receiving ACK/NAK.

First, as illustrated in FIG. 21, when the encryptor is waiting before transmitting and gets data (SDU) to be transmitted (steps 1111 and 1112), the encryptor attaches a BSN of ARQ to the data and stores the data for retransmission, associated with the BSN (step 1113). These processings can be performed by, e.g., the controller 25 (65) and PDU generator 14 (54) in cooperation. Also, association of the BSN with the data can be managed by, e.g., the memory 26.

Then the encryptor obtains a CTR value and encryption key for encrypting the data with the BSN attached, encrypts the data with the BSN attached, using the CTR value and encryption key, and stores the BSN and CTR value in a BSN/CTR table illustrated as an example in Table 6 below (step 1114). Note that, as illustrated in Table 6, a BSN and CTR value can be stored and managed for each CID. Also, the BSN/CTR table is stored in, e.g., the memory 26 (66).

TABLE 6
BSN/CTR Table

| CID | BSN | CTR |
|---|---|---|
| 143 | 42 | 535 |
| 324 | 765 | 9867 |
| 654 | 56 | 31 |
| . | . | . |
| . | . | . |
| . | . | . |

Then, the encryptor generates a PDU with the CTR value attached or with no CTR value attached depending on the necessity of attaching the CTR value through the same processing as in FIG. 6 (or FIG. 11, or FIG. 13), and transmits the PDU to the decryptor (steps 1115 to 1119).

As illustrated in FIG. 22, after transmitting the PDU, the encryptor waits for an ARQ message (ARQ-ACK/NAK) for the BSN of the PDU transmitted to the decryptor in a certain connection.

In this condition of waiting for receiving, for example, if an ARQ message is received (step 1122) and it is ARQ-NAK (“Yes” in step 1123), or if a timer that counts a predetermined time from transmitting a PDU till receiving a ARQ-ACK/NAK times out, the encryptor retrieves from the BSN/CTR table illustrated in Table 6 the CTR value corresponding to the CID and BSN specified by the received ARQ-NAK or the CID and BSN for which the timer times out (step 1124), generates a CTR-RSP message including this CTR value, and transmits it to the decryptor (step 1125).

If the ARQ message received from the decryptor is not ARQ-NAK (i.e., it is ARQ-ACK) ((“No” in step 1123), the encryptor preferably delete (erase) the entry in the BSN/CTR table corresponding to the CID and BSN specified by the received ARQ-ACK from the viewpoint of saving storage area of the BSN/CTR table (step 1126).

The operation of the decryptor after receiving the CTR-RSP message is the same as in the fourth embodiment (FIG. 18).

As have been described above, in accordance with the fifth embodiment, in response to receiving a retransmission request of ARQ (or HARQ) (ARQ-NAK) from the decryptor, the encryptor transmits to the decryptor a CTR-RSP message including the CTR value as in the fourth embodiment described previously. This allows the decryptor to establish resynchronization with the CTR value without requesting the retransmission of the CTR value from the encryptor (transmitting a CTR-REQ message to the encryptor), enabling the saving in radio resource (band).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) has(have) been described in detail, it should be understood that the various changes, substitutions, and alterations could be made hereto without departing from the spirit and scope of the invention.

What is claimed is:

1. A method of encryption and decryption in a radio communication system including a transmitter which encrypts data using an encryption key and transmits the encrypted data to a radio link and a receiver which receives the encrypted data via the radio link and decrypts the encrypted data using a decryption key paired with the encryption key, the method comprising:
at the transmitter,
encrypting data blocks using the encryption key and variable number information, the variable number information being sequentially updated for every encryption of the respective data blocks;
selectively attaching one of the variable number information used for encrypting the respective data blocks, to the encrypted data block encrypted by using the one of the variable number information; and
transmitting the encrypted data blocks including the encrypted data block with the variable number information attached, to the receiver;
at the receiver,
determining, based on (a) reception orders of a first encrypted data block with the variable number information attached and a second encrypted data block without the variable number information attached and (b) the variable number information attached to the first encrypted data block, variable number information used for encrypting the second encrypted data block; and
decrypting the second encrypted data block using the determined variable number information and the decryption key.

2. The method according to claim 1, wherein the encrypted data block with the variable number information attached by the transmitter is one of the more than one encrypted data blocks included in a predetermined transmission unit.

3. The method according to claim 2, wherein he encrypted data block with the variable number information attached in the transmission unit is the encrypted data block to be transmitted at the beginning of the transmission unit.

4. The method according to claim 1, further comprising:
at the transmitter,
controlling the number of the encrypted data blocks with the variable number information attached, depending on information indicating channel performance between the receiver and itself.

5. The method according to claim 4, wherein the control is such control that increases the number of the encrypted data blocks with the variable number information attached if the information indicating the channel performance is getting worse.

6. The method according to claim 4, wherein the information indicating the channel performance is measured by the receiver based on a signal received from the transmitter and is notified to the transmitter.

7. The method according to claim 4, wherein the information indicating the channel performance is such information that indicates the quality of radio channel in the radio link.

8. The method according to claim 4, wherein the information indicating the channel performance is such information that relates to the frequency of retransmitting the encrypted data block from the transmitter to the receiver.

9. The method according to claim 1, further comprising:
at the receiver,
in response to detecting an error in the first encrypted data block with the variable number information attached, transmitting an identifying information identifying the first encrypted data block with the error detected, to the transmitter; and
at the transmitter,
in response to receiving the identifying information, retransmitting the variable number information attached to the encrypted data block identified by the identifying information, to the receiver.

10. The method according to claim 1, further comprising:
at the receiver,
in response to detecting an error in the first encrypted data block with the variable number information attached, transmitting a retransmission request for the first encrypted data block with the error detected, to the transmitter; and
at the transmitter,
in response to receiving the retransmission request, transmitting the variable number information attached to the encrypted data block associated with the retransmission request, to the receiver.

11. A transmitter in a radio communication system including a transmitter which encrypts data using an encryption key and transmits the encrypted data to a radio link and a receiver which receives the encrypted data via the radio link and decrypts the encrypted data using a decryption key paired with the encryption key, the transmitter comprising:
an encryption unit operable to encrypt data blocks using the encryption key and variable number information, the variable number information being sequentially updated for every encryption of the respective data blocks; and
an transmission unit operable to selectively attach one of the variable number information used for encrypting the respective data blocks, to the encrypted data block encrypted by using the one of the variable number information, and to transmit the encrypted data blocks including the encrypted data block with the variable number information attached, to the receiver.

12. The transmitter according to claim 11, wherein the transmission unit attaches one of the variable number information used for encrypting the respective data blocks, to the encrypted data block encrypted by using the one of the variable number information, among the encrypted data blocks included in a predetermined transmission unit.

13. The transmitter according to claim 12, wherein the transmission unit attaches the variable number information to the encrypted data block to be transmitted at the beginning of the transmission unit.

14. The transmitter according to claim 11, further comprising a control unit operable to control the number of the encrypted data blocks with the variable number information attached, depending on information indicating channel performance between the receiver and itself.

15. The transmitter in a radio communication system according to claim 14, wherein the control unit increases the number of the encrypted data blocks with the variable number information attached if the information indicating the channel performance is getting worse.

16. The transmitter in a radio communication system according to claim 14, wherein the control unit receives information that the receiver measured based on a signal received from the transmitter, from the receiver as information indicating the channel performance.

17. The transmitter according to claim 14, wherein the information indicating the channel performance is such information that indicates the quality of radio channel in the radio link.

18. The transmitter according to claim 14, wherein the information indicating the channel performance is such information that relates to the frequency of retransmitting the encrypted data block to the receiver.

19. The transmitter according to claim 11, further comprising a reception unit operable to, when the receiver detects an error in the encrypted data block with the variable number information attached, receive an identifying information for identifying the encrypted data with the error detected, transmitted by the receiver,
wherein the transmission unit retransmits the variable number information attached to the encrypted data block identified by the identifying information, to the receiver.

20. The transmitter according to claim 11, further comprising a reception unit operable to, when the receiver detects an error in the encrypted data block with the variable number information attached, receive a retransmission request for the encrypted data block with the error detected, transmitted by the receiver,
wherein when the reception unit receives the retransmission request, the transmission unit transmits the variable number information attached to the first encrypted data block associated with the retransmission request, to the receiver.

21. A receiver in a radio communication system including a transmitter which encrypts data using an encryption key and transmits the encrypted data to a radio link and a receiver which receives the encrypted data via the radio link and decrypts the encrypted data using a decryption key paired with the encryption key, the receiver comprising:
a reception unit operable to receive from the transmitter, which encrypts data blocks using the encryption key and variable number information, the variable number information being sequentially updated for every encryption of the respective data blocks, selectively attaches one of the variable number information used for encrypting the respective data blocks, to the encrypted data block encrypted by using the one of the variable number information, and transmits the encrypted data blocks including the encrypted data block with the variable number information attached, the encrypted data blocks;
a variable number information determination unit operable to determine, based on (a) reception orders of a first encrypted data block with the variable number information attached and a second encrypted data block without the variable number information attached and (b) the variable number information attached to the first encrypted data block, variable number information used for encrypting the second encrypted data block; and
a decryption unit operable to decrypt the second encrypted data block using the variable number information determined by the variable number information determination unit and the decryption key.

22. The receiver according to claim 21, further comprising a transmission unit operable to, in response to detecting an error in the first encrypted data block with the variable number information attached, transmit an identifying information identifying the first encrypted data block with the error detected, to the transmitter,
wherein the decryption unit performs the decryption using the variable number information that was attached to the first encrypted data block, being received from the transmitter in response to the transmission of the identifying information by the transmission unit.

23. The receiver according to claim 21,
wherein the receiver further comprises a transmission unit operable to, in response to detecting an error in the first encrypted data block with the variable number information attached, transmit a retransmission request for the first encrypted data block with the error detected, to the transmitter; and
wherein the decryption unit performs the decryption using the variable number information that was attached to the first encrypted data block, being received from the transmitter in response to the retransmission request by the transmission unit.
